(19) United States
(12) Patent Application Publication
(10) Pub. No.: US 2024/0253355 A1
(43) Pub. Date: Aug. 1, 2024

(54) INKJET RECORDING DEVICE

(71) Applicant: KYOCERA CORPORATION, Kyoto-shi, Kyoto (JP)

(72) Inventors: Hiroatsu TAMAI, Osaka-shi, Osaka (JP); Masaaki MARUTA, Matsubara-shi, Osaka (JP); Daisuke ETO, Nishi-ku, Osaka-shi, Osaka (JP); Masahiro HIGASHITANI, Taishi-cho, Minamikawachi-gun, Osaka (JP); Tomoya HOTANI, Kimino-cho, Kaisou-gun, Wakayama (JP)

(21) Appl. No.: 18/291,920

(22) PCT Filed: Jul. 11, 2022
(86) PCT No.: PCT/JP2022/027300

§ 371 Date: Jan. 25, 2024

(30) Foreign Application Priority Data
Jul. 29, 2021 (JP) 2021-124065

(51) Int. Cl. B41J 2/165; B41J 2/17

(52) U.S. Cl. CPC B41J 2/16505; B41J 2/1721; B41P 2235/20

(57) ABSTRACT

An inkjet recording apparatus includes at least one head respectively ejecting liquid and a container including a container main body including an opening receiving the liquid ejected from the at least one head and a partition partitioning the container main body into a plurality of independent regions. The partition includes at least one first portion partitioning the container main body in a first direction and at least one second portion partitioning the container main body in a second direction intersecting the first direction.

### RELATED APPLICATIONS

The present application is a National Phase of International Application Number PCT/JP2022/027300 filed Jul. 11, 2022, which claims the benefit of priority from Japanese Patent Application No. 2021-124065, filed on Jul. 29, 2021.

### TECHNICAL FIELD

The present invention relates to an inkjet recording apparatus including a head ejecting a liquid.

### BACKGROUND OF INVENTION

An inkjet recording apparatus such as an inkjet printer includes a head ejecting a liquid such as an ink for image formation or a processing liquid toward a recording medium. In general, the inkjet recording apparatus includes a maintenance area where predetermined processing is applied to the head, in addition to a printing area where printing processing is performed. In the maintenance area, processing for eliminating clogging of nozzles ejecting a liquid and removing dirt and the like on a nozzle array surface of the head is performed. For this processing, a purge operation of ejecting a pressurized liquid from the nozzles, a wiping operation of wiping the nozzle array surface with a wiper including a wiping member such as a blade, and the like are performed. A container collecting a liquid falling from the head during the purge operation or the wiping operation is disposed in the maintenance area.

Patent Document 1 discloses a technique in which a container disposed in a maintenance region is partitioned into two collection chambers by a partition linearly extending in one direction. When liquids falling from a plurality of heads, respectively, are mixed with each other, a reaction may occur between the liquids, and the liquids may aggregate. Such an aggregation prevents the liquids from being ejected from the container. Thus, in each of the above-described techniques, in order to prevent liquids easily reacting with each other from being mixed with each other, a dedicated collection chamber is secured for each of the plurality of the liquids susceptible to reaction.

### CITATION LIST

### Patent Literature

Patent Document 1: JP 2014-008628 A

### SUMMARY

An inkjet recording apparatus of the present disclosure includes at least one head configured to eject liquid respectively; and a container comprising a container body with an opening, the opening being configured to receive liquid ejected from the at least one head, and a partition configured to partition the container body into a plurality of regions which are independent each other, wherein the partition comprises: at least one first portion configured to partition the container body in a first direction; and at least one second portion configured to partition the container body in a second direction intersecting the first direction.

### BRIEF DESCRIPTION OF THE DRAWINGS

FIG. 1 is a perspective view illustrating an overall configuration of an inkjet printer according to an embodiment of the present disclosure.

FIG. 2 is a schematic cross-sectional view taken along line II-II in FIG. 1.

FIG. 3 is an enlarged perspective view of a carriage and a maintenance unit illustrated in FIG. 1.

FIG. 4 is a schematic cross-sectional view of the carriage and the maintenance unit.

FIG. 5 is a block diagram illustrating a control configuration of the inkjet printer.

FIG. 6 is an overall perspective view of the maintenance unit.

FIG. 7 is a perspective view of a state in which a cleaning unit is removed from the maintenance unit illustrated in FIG. 6.

FIG. 8A is a perspective view of a state in which a wiping unit is further removed from the state in FIG. 7.

FIG. 8B is an enlarged view near a processing liquid container in FIG. 8A.

FIG. 9 is a view combining a plan view (region A) of the wiping unit and a plan view (region B) illustrating an arrangement of ink heads mounted on the carriage.

FIG. 10 is a perspective view of one of wipers included in the wiping unit.

FIG. 11A is a perspective view of the maintenance unit with a perspective direction different from that in FIG. 7.

FIG. 11B is an enlarged view of a drive system part of the wiping unit in FIG. 11A.

FIG. 12 is a perspective view for explaining a movement direction of the wiping unit.

FIG. 13 is a top view of the maintenance unit illustrating a movement path of the wiping unit.

FIG. 14A is a schematic cross-sectional view in the left-right direction illustrating an arrangement example of the processing liquid container without a region directly above an opening of an ink container.

FIG. 14B is a schematic cross-sectional view in the left-right direction illustrating an arrangement example of the processing liquid container without a region directly above the opening of the ink container.

FIG. 14C is a schematic cross-sectional view in the left-right direction illustrating an arrangement example of the processing liquid container without a region directly above the opening of the ink container.

FIG. 14D is a schematic top view illustrating an arrangement example of the processing liquid container without a region directly above the opening of the ink container.

FIG. 15A is a schematic view illustrating a movement range of a processing liquid wiper during wiping.

FIG. 15B is a schematic view illustrating a movement range of the processing liquid wiper during wiping.

FIG. 15C is a schematic view illustrating a movement range of the processing liquid wiper during wiping.

FIG. 16A is a schematic side view illustrating an ink wiper and its cleaning member.

FIG. 16B is a main portion perspective view of the maintenance unit illustrating an arrangement of the cleaning member illustrated in FIG. 16A.

FIG. 17 is a plan view illustrating an inclined arrangement of an ink blade and a processing liquid blade.

FIG. 18A is a view illustrating a wiping state of the head wiped by a blade having no inclination.

FIG. 18B is a view illustrating a wiping state of the head wiped by the processing liquid blade and the ink blade each having an inclination.

FIG. 18C is a view illustrating a wiping state of the head wiped by the processing liquid blade and the ink blade each having an inclination.

FIG. 19 is a perspective view of a container unit according to a first variation embodiment of the present disclosure.

FIG. 20 is a perspective view of a container unit according to a second variation embodiment of the present disclosure.

FIG. 21 is a perspective view of a container unit according to a third variation embodiment of the present disclosure.

FIG. 22 is a perspective view of a container unit according to a fourth variation embodiment of the present disclosure.

FIG. 23 is a perspective view of a container unit according to a fifth variation embodiment of the present disclosure.

FIG. 24 is a perspective view of a container unit according to a sixth variation embodiment of the present disclosure.

### DESCRIPTION OF EMBODIMENTS

An embodiment of the present disclosure will be described below with reference to the drawings. In the present embodiment, as a specific example of an inkjet recording apparatus, an inkjet printer including an ink head ejecting an ink for image formation onto a wide and long recording medium will be exemplified. The inkjet printer of the present embodiment is suitable for digital textile printing in which images such as characters and patterns are printed on a recording medium made of a fabric such as a woven fabric or a knitted fabric by an inkjet method. Of course, the inkjet recording apparatus according to the present disclosure can also be used to print various inkjet images on a recording medium such as a paper sheet or a resin sheet.

### Overall Configuration of Inkjet Printer

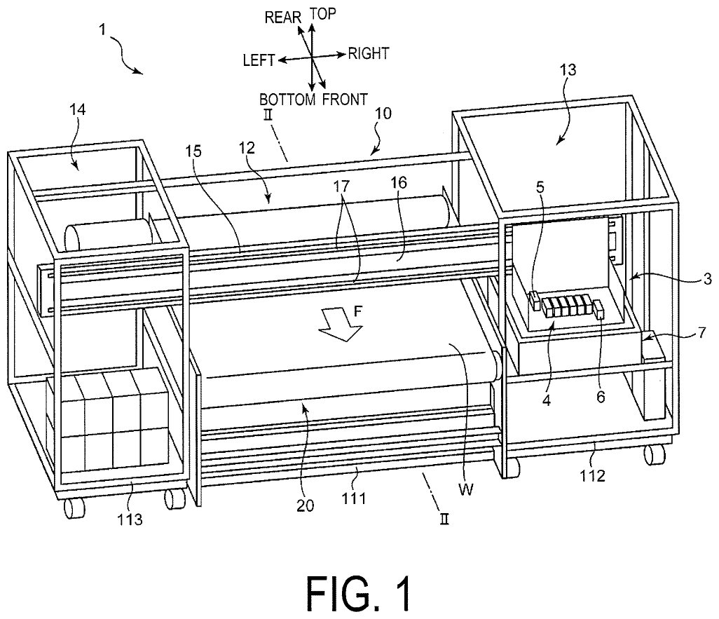

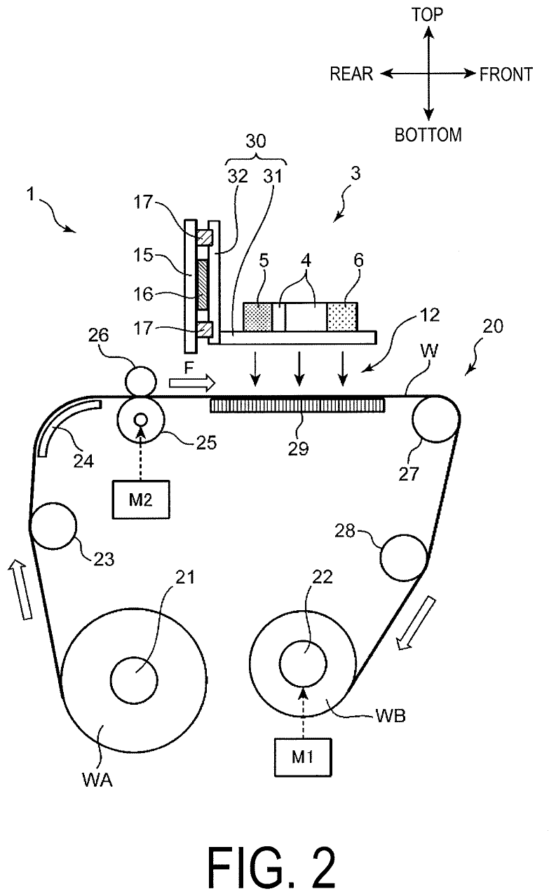

FIG. 1 is a perspective view illustrating an overall configuration of an inkjet printer 1 according to an embodiment of the present disclosure, and FIG. 2 is a schematic cross-sectional view taken along line II-II in FIG. 1. The inkjet printer 1 is a printer that prints an image on a wide and long workpiece W by the inkjet method, and includes a apparatus frame 10, and a workpiece conveying portion 20 and a carriage 3 that are incorporated in the apparatus frame 10. In the present embodiment, the left-right direction is a main scanning direction during printing on the workpiece W, and a direction from the rear toward the front is a sub scanning direction that is a conveyance direction F of the workpiece W.

The apparatus frame 10 forms a framework for mounting various constituent members of the inkjet printer 1. The workpiece conveying portion 20 is a mechanism intermittently feeding the workpiece W so that the workpiece W advances in the conveyance direction F from the rear toward the front in a printing region where the inkjet printing processing is performed. An ink head 4, a pre-processing head 5, a post-processing head 6, and a sub-tank (not illustrated) are mounted on the carriage 3, and the carriage 3 reciprocates in the left-right direction during the inkjet printing processing.

The apparatus frame 10 includes a center frame 111, a right frame 112 and a left frame 113. The center frame 111 forms a framework on which various constituent members of the inkjet printer 1 are mounted, and has a left-right width corresponding to the workpiece conveying portion 20. The right frame 112 is erected to the right of the center frame 111, and the left frame 113 is erected to the left of the center frame 111. A space between the right frame 112 and the left frame 113 is a printing area 12 in which the printing processing is executed on the workpiece W.

The right frame 112 forms a maintenance area 13. The maintenance area 13 is an area in which the carriage 3 is retracted when the printing processing is not executed. A maintenance unit 7 is disposed in the maintenance area 13. The maintenance unit 7 is located below the retracted carriage 3. The maintenance unit 7 is a unit for performing wiping processing of wiping a lower surface (nozzle array surface) of each of the ink head 4, the pre-processing head 5, and the post-processing head 6, and purging processing of purging the nozzles. The maintenance unit 7 also functions as a cap for preventing the heads 4, 5, and 6 from drying when the heads 4, 5, and 6 are at rest. The left frame 113 forms a return area 14 of the carriage 3. The return area 14 is an area into which the carriage 3 that has scanned the printing area 12 from right to left in the printing processing temporarily enters before scanning in the reverse direction.

A carriage guide 15 for causing the carriage 3 to reciprocate in the left-right direction is assembled on the upper side of the apparatus frame 10. The carriage guide 15 is a flat plate shape member that is long in the left-right direction, and is disposed above the workpiece conveying portion 20. A timing belt 16 is attached to the carriage guide 15 so as to be capable of circumferential movement in the left-right direction (main scanning direction). The timing belt 16 is an endless belt, and is driven by a drive source (not illustrated) so as to perform the circumferential movement in the left or right direction.

The carriage guide 15 is provided with a pair of upper and lower guide rails 17 that extend parallel to each other in the left-right direction. The carriage 3 includes an engaging portion with respect to the guide rails 17. The carriage 3 is fixed to the timing belt 16. The carriage 3 moves in the left direction or the right direction along the carriage guide 15 while being guided by the guide rails 17 as the timing belt 16 moves in a left or right circumferential direction.

Referring mainly to FIG. 2, the workpiece conveying portion 20 includes a feeding roller 21 feeding the workpiece W before printing and a winding roller 22 winding the workpiece W after printing. The feeding roller 21 is disposed at a rear lower portion of the apparatus frame 10 and is a winding shaft of a feeding roll WA that is a wound body of the workpiece W before printing. The winding roller 22 is disposed at a front lower portion of the apparatus frame 10 and is a winding shaft of a winding roll WB that is a wound body of the workpiece W after being subjected to the printing process. A first motor M1 rotationally driving the winding roller 22 around the shaft and causing the winding roller 22 to execute a winding operation of the workpiece W is attached to the winding roller 22.

A path between the feeding roller 21 and the winding roller 22 and passing through the printing area 12 serves as a conveyance path of the workpiece W. In the conveyance path, a first tension roller 23, a workpiece guide 24, a conveyance roller 25 and a pinch roller 26, a return roller 27, and a second tension roller 28 are disposed in this order from the upstream side. The first tension roller 23 applies a predetermined tension to the workpiece W on the upstream side of the conveyance roller 25. The workpiece guide 24 changes the conveyance direction of the workpiece W from the upward direction to the forward direction and conveys the workpiece W into the printing area 12.

The conveyance roller 25 generates a conveyance force intermittently feeding the workpiece W in the printing area 12. The conveyance roller 25 is rotationally driven around the shaft by a second motor M2. The conveyance roller 25 intermittently conveys the workpiece W in the forward direction (conveyance direction F) so that the workpiece W passes through the printing area 12 facing the carriage 3. The pinch roller 26 is disposed to face the conveyance roller 25 from above, and forms a conveyance nip portion with the conveyance roller 25. The return roller 27 changes the conveyance direction of the workpiece W that has passed through the printing area 12 from the forward direction to the downward direction, and guides the workpiece W after the printing process to the winding roller 22. The second tension roller 28 applies a predetermined tension to the workpiece W on the downstream side of the conveyance roller 25. A platen 29 is disposed below the conveyance path of the workpiece W in the printing area 12.

The carriage 3 reciprocates in the main scanning direction (left-right direction) intersecting the conveyance direction F in a state of being cantilevered by the guide rails 17. The carriage 3 includes a carriage frame 30, and the ink head 4, the pre-processing head 5, the post-processing head 6, and a sub-tank (not illustrated) mounted on the carriage frame 30. The carriage frame 30 includes a head support frame 31 and a back frame 32. The head support frame 31 is a horizontal plate holding the above-described heads 4 to 6. The back frame 32 is a vertical plate extending upward from a rear end edge of the head support frame 31. The timing belt 16 is fixed to the back frame 32, and the guide rails 17 are engaged with the back frame 32.

### Details of Carriage

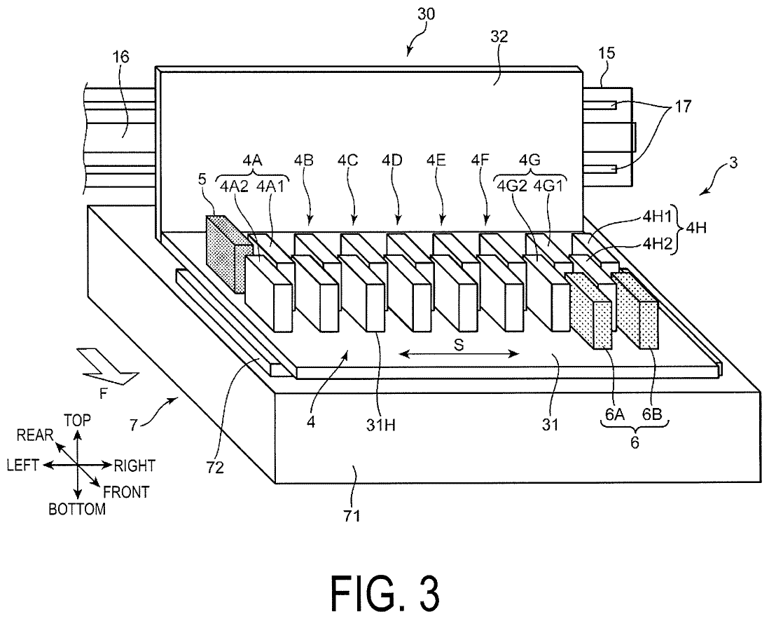

The carriage 3 will be further described. FIG. 3 is an enlarged perspective view of the carriage 3 illustrated in FIG. 1, and also illustrates the maintenance unit 7. FIG. 3 illustrates the conveyance direction F (sub scanning direction) of the workpiece W and a main scanning direction S that is a movement direction of the carriage 3. FIG. 3 illustrates an example in which a plurality of ink heads 4 each ejecting the ink for image formation onto the workpiece W, and the pre-processing head 5 and the post-processing head 6 ejecting a non-color-developing processing liquid are mounted on the carriage 3. A plurality of the sub-tanks supplying each of the ink and processing liquid to the heads 4, 5, and 6, are also mounted on the actual carriage 3. The number of heads is not limited to the above, and at least one head may be disposed. The processing liquid may be called as a treatment liquid.

Each of the ink heads 4 includes a large number of nozzles each ejecting ink droplets by a eject method such as a piezoelectric method using a piezoelectric element or a thermal method using a heating element, and an ink passage guiding an ink to the nozzles. As the ink, for example, an aqueous pigment ink containing an aqueous solvent, a pigment, and a binder resin can be used. The plurality of ink heads 4 in the present embodiment include first to eighth ink heads 4A to 4H ejecting eight color inks, respectively, different from each other.

The ink heads 4A to 4H of the respective colors are mounted on the head support frame 31 of the carriage 3 so as to be arranged in the main scanning direction S. Each of the ink heads 4A to 4H of the respective colors includes two heads. For example, the first ink head 4A includes an upstream-side head 4A1 disposed on the upstream side in the conveyance direction F and a downstream-side head 4A2 disposed at a position on the downstream side of the upstream-side head 4A1 and shifted to the left side in the main scanning direction S. The same applies to the ink heads 4B to 4H of the other colors, respectively. The upstream-side heads of the ink heads 4B to 4H, respectively, are arranged in a row in the main scanning direction S at the same position as the upstream-side head 4A1 in the conveyance direction F, and the downstream-side heads are arranged in a row in the main scanning direction S at the same position as the downstream-side head 4A2 in the conveyance direction F.

The pre-processing head 5 (processing liquid head) and the post-processing head 6 (processing liquid head) are disposed at positions different from the positions of the ink heads 4 in the conveyance direction F. The pre-processing head 5 is disposed on the upstream side of the ink heads 4 in the conveyance direction F. FIG. 3 illustrates an example in which one pre-processing head 5 is disposed near a left end of an array of the ink heads 4. On the other hand, the post-processing head 6 is disposed on the downstream side of the ink heads 4 in the conveyance direction F. FIG. 3 illustrates an example in which two post-processing heads 6A and 6B are disposed so as to be arranged in the main scanning direction S near the right end of the array of the ink heads 4.

The pre-processing head 5 ejects a pre-processing liquid (processing liquid) for applying predetermined pre-processing to the workpiece W. The pre-processing liquid is ejected from the pre-processing head 5 to a position of the workpiece W to which the ink is not ejected from the ink head 4. The pre-processing liquid is a non-color-developing processing liquid that does not develop a color even when adhering to the workpiece W, and is a processing liquid exhibiting, for example, a function of enhancing the fixability of the ink to the workpiece W and/or the aggregation property of an ink pigment. As such a pre-processing liquid, a processing liquid in which a binding resin is blended in a solvent, a processing liquid in which a cationic resin positively charged is blended in a solvent, or the like can be used.

The post-processing head 6 ejects a post-processing liquid (processing liquid) for applying predetermined post-processing to the workpiece W to which the ink adheres. The post-processing liquid is ejected from the post-processing head 6 to a position of the workpiece W after the ink is ejected from the ink head 4. The post-processing liquid is also a non-color-developing processing liquid that does not develop color even when adhering to the workpiece W, and is a processing liquid exhibiting a function of enhancing the fixability and fastness of an ink image printed on the workpiece W by the ink head 4. Here, “fastness” means resistance to rubbing and scraping. As such a post-processing liquid, a silicone-based processing liquid or the like can be used.

Here, the non-color-developing processing liquid refers to a processing liquid that is not recognized by a person by the naked eye as having developed color when printed alone on the recording medium. Here, the color includes a color having a saturation of 0, such as black, white, and gray. The non-color-developing processing liquid is basically a transparent liquid, but for example, when one liter of the processing liquid is viewed in a liquid state, the non-color-developing processing liquid may not be completely transparent and may appear slightly white or the like. Since such a color is very light, a person cannot recognize that the color is developed by the naked eye when the color is printed alone on the recording medium. Depending on the type of processing liquid, when printed alone on the recording medium, there may be changes in the recording medium such as a glossy appearance, but such a state is not considered to be color development.

Openings 31H are provided at the arrangement positions of the heads, respectively, on the head support frame 31. The ink heads 4A to 4F, the pre-processing head 5, and the post-processing head 6 are attached to the head support frame 31 so as to be fitted into the openings 31H, respectively. The nozzles disposed on the lower end surface of each of the heads 4, 5, and 6 are exposed from respective ones of the openings 31H.

As described above, in the present embodiment, the inkjet printer 1 is an all-in-one type printer in which three types of heads of the ink heads 4, the pre-processing head 5, and the post-processing head 6 are mounted on one carriage 3. According to the printer 1, for example, in printing processing of performing inkjet printing on a fabric in digital textile printing, ejecting processing of the pre-processing liquid and ejecting processing of the post-processing liquid can be integrally executed. Thus, the printing processing can be simplified and the printing apparatus can be made compact.

### Schematic Configuration of Maintenance Unit

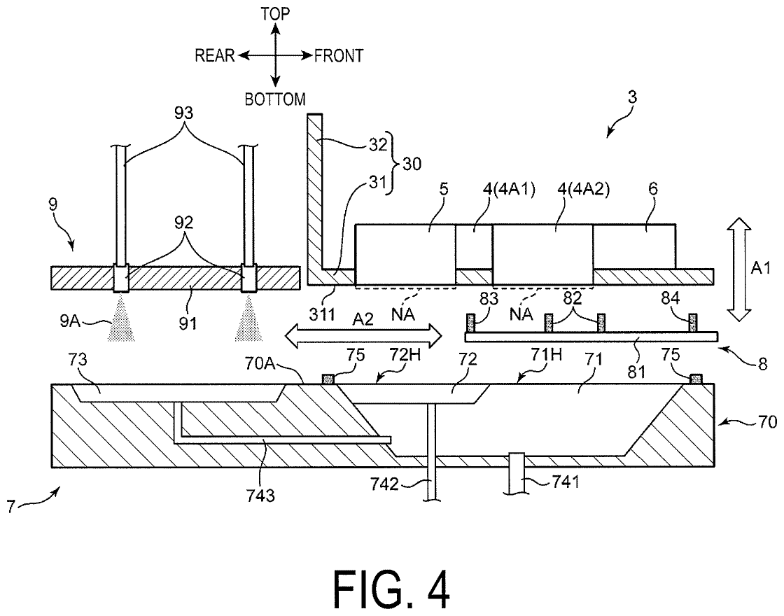

FIG. 4 is a schematic cross-sectional view of the carriage 3 and the maintenance unit 7 along the front-rear direction. The maintenance unit 7 includes a container unit 70, a wiping unit 8, and a cleaning unit 9. The maintenance area 13 (FIG. 1) is an area in which processing of eliminating clogging of the nozzles of each of the heads 4, 5, and 6 and removing dirt and the like on a nozzle array surface NA of each of the heads 4, 5, and 6 is performed. For this processing, the purge operation, the wiping operation, and a cleaning operation are executed in the maintenance area 13.

The purge operation is an operation of forcibly ejecting pressurized inks, the pre-processing liquid, and the post-processing liquid from the ink heads 4, the pre-processing head 5, and the post-processing head 6, respectively. The container unit 70 collects the inks, the pre-processing liquid, and the post-processing liquid ejected from the heads 4, 5, and 6, respectively, during the purge operation. The wiping operation is an operation of wiping the nozzle array surface NA with a wiper including a wiping member such as a blade. The wiping unit 8 is a unit that executes the wiping operation. The cleaning operation is an operation of cleaning the wiping unit 8 contaminated by the execution of the wiping operation. The cleaning unit 9 is a unit executing the above-described cleaning operation. The container unit 70 also collects a cleaning liquid used in the cleaning operation.

The container unit 70 has a structure in which the pre-processing liquid is collected separately from the ink and the post-processing liquid. In the present embodiment, as described above, the processing liquid enhancing the fixability of the ink and the aggregation property of the ink pigment is used as the pre-processing liquid. Thus, when the pre-processing liquid and the ink are mixed with each other, the mixed liquid may aggregate and cause trouble when being collected in a waste liquid tank. On the other hand, even if the post-processing liquid used in the present embodiment is mixed with the ink, aggregation or the like does not occur. This is the reason for the above-described separate collection in the container unit 70.

The container unit 70 includes an ink container 71, a pre-processing liquid container 72 (processing liquid container), and a cleaning liquid tray 73 (cleaning container portion). The ink container 71 is a container collecting the inks and the post-processing liquid ejected from the ink heads 4 and the post-processing head 6, respectively, in the purge operation. The ink container 71 includes, at an upper surface thereof, a first opening 71H that receives the inks and the post-processing liquid. The first opening 71H opens upward at a position facing at least the nozzle array surface NA of each of the ink heads 4 and the post-processing head 6 in the up-down direction. The ink container 71 also collects the inks and the post-processing liquid wiped from the nozzle array surfaces NA in the wiping operation.

The pre-processing liquid container 72 is disposed at a position covering a part of the upper side of the first opening 71H. The pre-processing liquid container 72 is a container collecting the pre-processing liquid ejected from the pre-processing head 5 in the purge operation. The pre-processing liquid container 72 includes, at an upper surface thereof, a second opening 72H receiving the pre-processing liquid. The second opening 72H is open upward at a position facing at least the nozzle array surface NA of the pre-processing head 5 in the up-down direction. The pre-processing liquid container 72 also collects the pre-processing liquid wiped from the nozzle array surface NA in the wiping operation. The cleaning liquid tray 73 is a container collecting (receiving) a cleaning liquid 9A injected from the cleaning liquid cleaning unit 9 and passed through each wiper in the cleaning operation.

The container unit 70 includes an overflow passage 741, a processing liquid passage 742, and a relay passage 743 for circulation of the collected liquid. The overflow passage 741 is a passage including a starting end opening at a bottom surface of the ink container 71 and a terminal end side located toward a waste liquid container (not illustrated). The processing liquid passage 742 is a passage including a starting end opening near a bottom surface of the pre-processing liquid container 72 and a terminal end side located toward the waste liquid container. The relay passage 743 is a passage including a starting end opening at a bottom surface of the cleaning liquid tray 73 and a terminal end opening near the bottom surface of the ink container 71. That is, the cleaning liquid 9A collected in the cleaning liquid tray 73 is once introduced into the ink container 71 and then collected in the waste liquid container through the overflow passage 741.

A cap rubber 75 is mounted on an upper surface 70A of the container unit 70. The cap rubber 75 is disposed so as to surround the peripheral edge of the first opening 71H of the ink container 71. The carriage 3 is movable in the up-down direction as indicated by an arrow A1 in the drawing. When the carriage 3 enters a standby mode in the maintenance area 13, when the printer 1 is at rest, or the like, the carriage 3 is lowered and a lower surface 311 of the head support frame 31 is brought into surface contact with the cap rubber 75. As a result, the nozzle array surface NA of each of the heads 4, 5, and 6 is sealed.

The wiping unit 8 includes a wiper support plate 81 (support member), and ink wipers 82, a pre-processing liquid wiper 83 (processing liquid wiper), and a post-processing liquid wiper 84 which are supported by the wiper support plate 81. The wiping unit 8 is movable in the front-rear direction as indicated by an arrow A2 in the drawing. The wiper support plate 81 is a flat plate shape member and moves in the front-rear direction between the carriage 3 and the cleaning unit 9, and the container unit 70. The ink wiper 82 wipes the nozzle array surface NA of the ink head 4 by moving in the rearward direction while being in contact with the nozzle array surface NA. Similarly, the pre-processing liquid wiper 83 and the post-processing liquid wiper 84 wipe the nozzle array surfaces NA of the pre-processing head 5 and the post-processing head 6, respectively.

In the present embodiment, the heads 4, 5, and 6 eject only the inks, the pre-processing liquid, and the post-processing liquid, respectively. However, one head may include nozzles ejecting the ink and nozzles ejecting at least one of the pre-processing liquid and the post-processing liquid. In this case, at least the nozzles ejecting the ink and the nozzles ejecting the pre-processing liquid are separately disposed in different regions and are wiped by wipers, respectively, different from each other. The heads 4, 5, and 6 eject only the inks, the pre-processing liquid, and the post-processing liquid, respectively, and thus the likelihood of the inks being mixed with the pre-processing liquid or the post-processing liquid can be reduced.

The cleaning unit 9 includes a nozzle holding plate 91 and a plurality of cleaning nozzles 92 (injection portions) held by the nozzle holding plate 91. The nozzle holding plate 91 is made of a flat plate shape member and is fixedly disposed so as to face the cleaning liquid tray 73 of the container unit 70. The plurality of cleaning nozzles 92 are disposed at positions corresponding to the ink wipers 82, the pre-processing liquid wiper 83, and the post-processing liquid wiper 84, respectively, mounted on the wiper support plate 81. That is, when the wiping unit 8 moves to a predetermined position directly below the cleaning unit 9, the plurality of cleaning nozzles 92 are held by the nozzle holding plate 91 at positions facing the wipers 82, 83, and 84, respectively, from above. Each of the cleaning nozzles 92 dissipates (injects) the cleaning liquid 9A in a fan-shaped spray form. The cleaning liquid 9A is supplied to the cleaning nozzle 92 from a cleaning liquid tank (not illustrated) via a cleaning liquid hose 93.

### Control Configuration

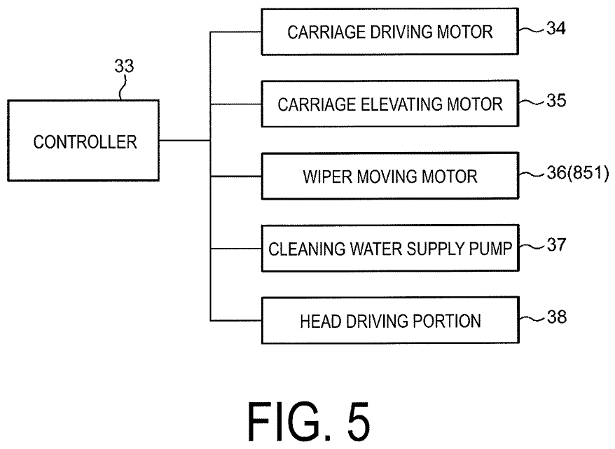

FIG. 5 is a block diagram illustrating a part of a control configuration of the printer 1. The printer 1 includes a controller 33, a carriage driving motor 34 whose operation is controlled by the controller 33, a carriage elevating motor 35, a wiper-moving motor 36, a cleaning water supply pump 37, and a head driving portion 38.

The carriage driving motor 34 generates a driving force moving the carriage 3 in the left-right direction within a range of the return area 14, the printing area 12, and the maintenance area 13 (FIG. 1). The carriage driving motor 34 drives the timing belt 16 (FIGS. 1 to 3). The carriage elevating motor 35 generates a driving force moving the carriage 3 in the up-down direction in the maintenance area 13. The wiper-moving motor 36 generates a driving force moving the wiping unit 8 in the front-rear direction. The cleaning water supply pump 37 is connected to the cleaning liquid hose 93 and supplies the cleaning liquid 9A to the cleaning nozzle 92 at a predetermined pressure. The head driving portion 38 executes a eject operation of ejecting the inks, the pre-processing liquid, and the post-processing liquid from the heads 4, 5, and 6, respectively.

When the purge operation is executed, the controller 33 controls the wiper-moving motor 36 to move the wiping unit 8 rearward to a retracted position below the cleaning unit 9. Next, the controller 33 controls the head driving portion 38 to eject the inks, the pre-processing liquid, and the post-processing liquid from the heads 4, 5, and 6, respectively, at a high pressure to clean the nozzles. The inks and the post-processing liquid, and the pre-processing liquid ejected by the purge operation are collected by the ink container 71 and the pre-processing liquid container 72, respectively.

When the wiping operation is executed, the controller 33 controls the wiper-moving motor 36 to move the wiping unit 8 to the foremost wiping start position. Next, the controller 33 controls the carriage elevating motor 35 to lower the nozzle array surface NA of each of the heads 4, 5, and 6 to height positions coming into contact with the wipers 82, 83, and 84, respectively, of the wiping unit 8. Thereafter, the controller 33 moves the wiping unit 8 rearward. The inks and the post-processing liquid wiped from the nozzle array surfaces NA by the wiping of the ink wipers 82 and the post-processing liquid wiper 84, respectively, are collected by the ink container 71. In addition, the pre-processing liquid wiped from the nozzle array surface NA by the wiping of the pre-processing liquid wiper 83 is collected by the pre-processing liquid container 72.

When the cleaning operation is executed, the controller 33 controls the wiper-moving motor 36 to move the wiping unit 8 rearward to a retracted position below the cleaning unit 9. Next, the controller 33 controls the cleaning-water supply pump 37 to supply the cleaning liquid 9A to the cleaning nozzle 92 via the cleaning liquid hose 93. As a result, the cleaning liquid 9A is sprayed onto each of the wipers 82, 83, and 84 of the wiping unit 8, and foreign matter adhering to the wipers 82, 83, and 84 due to the wiping is removed. The cleaning liquid 9A is collected in the cleaning liquid tray 73.

### Detailed Structure of Maintenance Unit

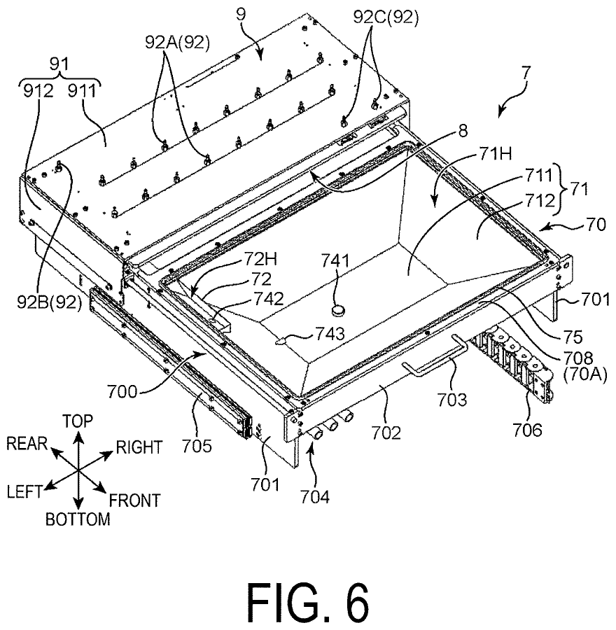

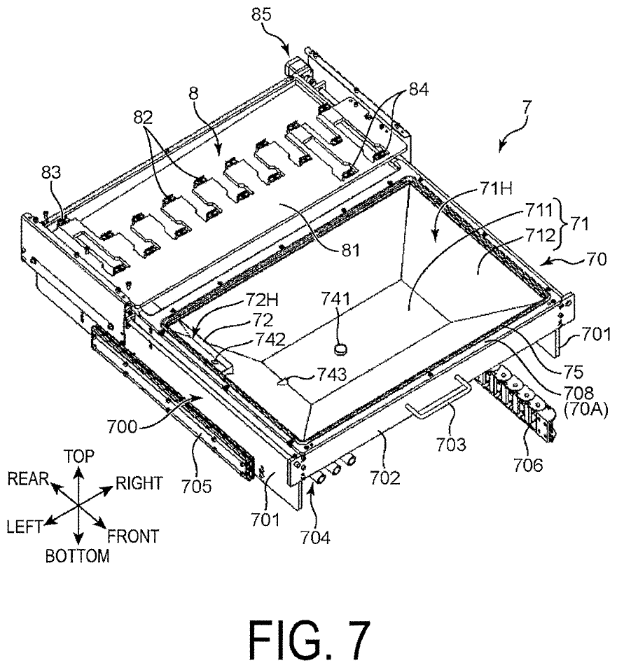

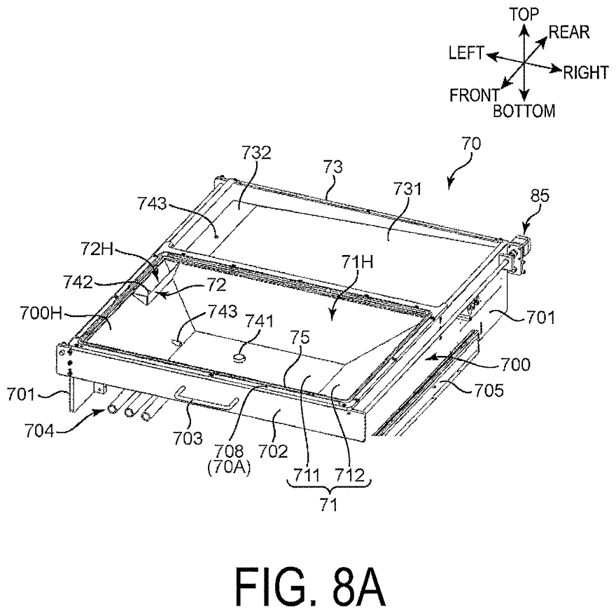

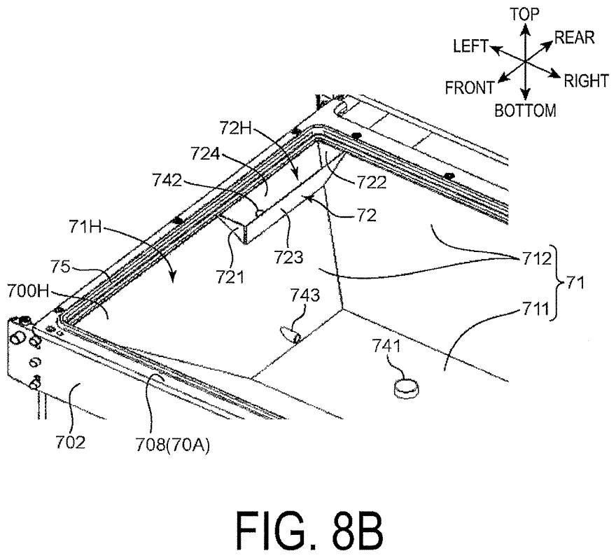

Next, one specific embodiment of the above-described maintenance unit 7 will be illustrated and a detailed structure thereof will be described. FIG. 6 is an overall perspective view of the maintenance unit 7, FIG. 7 is a perspective view illustrating a state in which the cleaning unit 9 is removed from FIG. 6, FIG. 8A is a perspective view illustrating a state in which the wiping unit 8 is further removed from the state illustrated in FIG. 7, and FIG. 8B is an enlarged view near the pre-processing liquid container 72 in FIG. 8A. FIGS. 6 and 7, illustrate a standby state of waiting for a wiping command or a state in which the cleaning operation is executed and illustrate a state in which the wiping unit 8 is moved to the rearmost end side.

As described above, the maintenance unit 7 includes the container unit 70, the wiping unit 8, and the cleaning unit 9 (cleaning portion). The container unit 70 is mounted on the apparatus frame 10 (FIG. 1) so as to be capable of being pulled out forward in the maintenance area 13. The wiping unit 8 is assembled so as to be movable with respect to the container unit 70 in the front-rear direction. The cleaning unit 9 is fixedly attached to the apparatus frame 10.

### Container Unit

The container unit 70 includes a frame structure 700 having a rectangular parallelepiped shape slightly elongated in the front-rear direction, the ink container 71 and the pre-processing liquid container 72 disposed on the front side of the frame structure 700, and the cleaning liquid tray 73 (cleaning portion) disposed on the rear side of the frame structure 700. The frame structure 700 includes a pair of left and right side frames 701 extending in the front-rear direction, and a front frame 702 connecting front ends of the side frames 701 with each other.

A handle 703 for pulling out the container unit 70 forward is mounted on the front frame 702. A plurality of waste liquid hoses 704 are drawn out from below the front frame 702. The waste liquid hoses 704 connect the overflow passage 741 communicating with a cavity of the ink container 71 and the processing liquid passage 742 communicating with a cavity of the pre-processing liquid container 72 to a waste liquid tank (not illustrated). Sliders 705 are mounted on outer side surfaces of the pair of side frames 701, respectively. The sliders 705 engage with guide rails (not illustrated) fixed to the apparatus frame 10, and enable the container unit 70 to be pulled out forward from the apparatus frame 10 (housing). At this time, the wiping unit 8, which will be described later in detail, is also capable of being pulled out integrally with the container unit 70. Thus, the container unit 70 and the wiping unit 8 can be easily cleaned and maintained. In another embodiment, the cleaning unit 9 may also be pulled out integrally. A chain protector 706 accommodating an electric cable, a hose, and the like is provided below the frame structure 700. The chain protector 706 deforms as the container unit 70 is pulled out.

The ink container 71 is a saucer-shaped container, and an upper surface of the ink container 71 includes the first opening 71H having a rectangular shape elongated in the left-right direction. The ink container 71 includes a bottom surface 711 having a rectangular shape elongated in the left-right direction, four tapered surfaces 712 extending upward from four end edges of the bottom surface 711, respectively, and an upper end flange 708 formed on the peripheral edge of the first opening 71H. The ink container 71 is a separate body from the frame structure 700 and is fitted into the frame structure 700. The upper end flange 708 of the ink container 71 is supported by the side frames 701 and the front frame 702. A starting end opening of the overflow passage 741 protrudes upward from the bottom surface 711 by a predetermined length. A terminal end opening of the relay passage 743 protrudes from the vicinity of a lower end of the tapered surface 712 on the left side.

The size of the first opening 71H in the left-right direction is substantially equal to a distance between the pair of side frames 701. The size of the first opening 71H in the front-rear direction is slightly larger than half of a front-rear width of the container unit 70. The cap rubber 75 disposed so as to surround the periphery of the first opening 71H is mounted on the upper surface of the upper end flange 708. The upper end flange 708 is a portion corresponding to the upper surface 70A illustrated in the schematic view in FIG. 4. The head support frame 31 of the carriage 3 has a size larger than a region surrounded by the cap rubber 75. On the other hand, an array region of the heads 4, 5, and 6 held by the head support frame 31 has a size slightly smaller than the size of the first opening 71H. The cap rubber 75 comes into contact with the lower surface 311 of the head support frame 31 at the outer periphery of the array region of the heads 4, 5, and 6, and seals the nozzle array surface NA of each of the heads 4, 5, and 6. As described above, in the present embodiment, the container unit 70 also serves as a head cap that can cap the ink head 4, the pre-processing head 5, and the post-processing head 6.

Referring to FIGS. 8A and 8B, the pre-processing liquid container 72 is disposed at a position on the left rear of the ink container 71 so as to cover a part of the first opening 71H. The placement position of the pre-processing liquid container 72 is a position to which the pre-processing head 5 held by the carriage 3 directly faces during wiping. As will be described later, when the pre-processing head 5 is disposed at the center or near the right end of the head support frame 31, the pre-processing liquid container 72 is also disposed at a position corresponding thereto. An upper surface of the pre-processing liquid container 72 includes a second opening 72H having a rectangular shape elongated in the front-rear direction so as to correspond to the shape of the nozzle array surface NA of the pre-processing head 5. In the present embodiment, the second opening 72H is at the same height position as the first opening 71H. In other words, the second opening 71H occupies a part of the original region of the first opening 72H.

The pre-processing liquid container 72 is formed by a front wall 721, a rear wall 722, a right wall 723, and a left wall 724. Among these walls, the rear wall 722 uses a portion near the upper end of the tapered surface 712 on the rear side of the ink container 71, and the left wall 724 uses a portion near the upper end of the tapered surface 712 on the left side. The front wall 721 is a wall at the vicinity of an upper end of the tapered surface 712 on the left side and protruding to the right from the vicinity of the center of the tapered surface 712 in the front-rear direction. The right wall 723 is a wall connecting right end edges of the front wall 721 and the rear wall 722, respectively, with each other. The right wall 723 is inclined in the upper right direction at a slight angle from the tapered surface 712 that is on the left side and inclined to the lower right.

In other words, regarding the structure of the container unit 70 described above, the container unit 70 includes a container main body 700H (FIGS. 8A and 8B) including an opening receiving the liquids ejected from the plurality of heads, respectively, and a partition partitioning the container main body 700H into a plurality of independent regions. In the present embodiment, the front wall 721 and the right wall 723 in FIG. 8B correspond to the partitions. The partitions partition the container main body 700H into the ink container 71 and the pre-processing liquid container 72. At this time, the front wall 721 (first portion) partitions the container main body 700H in the front-rear direction, and the right wall 723 (second portion) is connected to the front wall 721 and partitions the container main body 700H in the left-right direction.

As described above, in the present embodiment, the partitions partition the container main body 700H of the container unit 70 along two directions, and thus a plurality of types of liquids which are desired to be prevented from being mixed with each other can be separately collected, and the degree of freedom in the arrangement of the corresponding heads can be increased. In particular, as illustrated in FIG. 3, even in the case where the ink heads 4, the pre-processing head 5, and the post-processing heads 6 are disposed in a complicated manner as exemplified by a staggered arrangement, the ink container 71 and the pre-processing liquid container 72 can be disposed below corresponding ones of the respective heads.

Here, receiving the liquid means receiving the liquid falling from above. Although the liquid flows from the cleaning liquid tray 73 into the ink container 71 through the relay passage 743, this is not included in the above-described reception of the liquid. The liquid flowing from the cleaning liquid tray 73 contains a small amount of inks, the pre-processing liquid, and the post-processing liquid in addition to the cleaning liquid. However, the concentration of the pre-processing liquid is low, and thus the pre-processing liquid does not substantially coagulate even when the pre-processing liquid enters the ink container 71. A partition may be provided in the cleaning liquid tray 73 so as to enable a liquid containing no pre-processing liquid to flow into the ink container 71.

In the present embodiment, by collecting the inks and the post-processing liquid in the ink container 71 while collecting the pre-processing liquid in the dedicated pre-processing liquid container 72, the pre-processing liquid that is likely to aggregate when mixed with the ink can be prevented from being mixed with the ink, and both of the two types of processing liquids can be easily ejected.

In the present embodiment, the bottom surface of the pre-processing liquid container 72 is disposed above the bottom surface of the ink container 71. That is, the depth of the pre-processing liquid container 72 is shallower than the depth of the ink container 71. Thus, fixation of the pre-processing liquid having a relatively small eject amount to the inner wall of the pre-processing liquid container 72 can be reduced, and the pre-processing liquid can be easily ejected from the pre-processing liquid container 72. The depth of the pre-processing liquid container 72 is a depth from the upper end of the partition partitioning the pre-processing liquid container 72 and the ink container 71 to the lowest portion of the pre-processing liquid container 72. The depth of the ink container 71 is the depth from the upper end of the above-described partition to the lowest portion of the ink container 71.

In particular, in the present embodiment, the container main body 700H of the container unit 70 includes an inclined surface (tapered surface 712 on the left side in FIG. 8B) defining the ink container 71 together with the partition. A part of the inclined surface further defines the pre-processing liquid container 72 (left wall 724) above the bottom surface 711 of the ink container 71, and thus the depth of the pre-processing liquid container 72 is set to be shallower than the depth of the ink container 71. In other words, the pre-processing liquid container 72 is formed using a region from the upper end edge of the tapered surface 712 on the left side to the middle of the above-described tapered surface 712. Thus, the ink container 71 and the pre-processing liquid container 72 can be formed using the inclined surface, and the rigidity of the pre-processing liquid container 72 can be increased by attaching the pre-processing liquid container 72 to the ink container 71. Thus, as compared with a case where all wall portions defining the pre-processing liquid container 72 are completely independent from the ink container 71, deformation of the pre-processing liquid container 72 due to the influence of gravity can be suppressed.

Further, in the present embodiment, the left wall 724 (FIG. 8B) of the pre-processing liquid container 72 is inclined so as to be capable of guiding the pre-processing liquid received from the pre-processing head 5 to the right direction (predetermined direction) as the pre-processing liquid proceeds downward. Similarly, the right wall 723 is inclined so as to be capable of guiding the pre-processing liquid received from the pre-processing head 5 to the left direction (predetermined direction) as the pre-processing liquid proceeds downward. The pre-processing liquid guided along the right wall 723 and the left wall 724 is collected at a portion where both walls intersect each other, and is ejected from the processing liquid passage 742. Inner surfaces of the right wall 723 and the left wall 724, respectively, correspond to the bottom surface of the pre-processing liquid container 72 as viewed in a plan view of the pre-processing liquid container 72.

The cleaning liquid tray 73 is a container including an upper surface opening having a rectangular shape elongated in the left-right direction and has a smaller depth than the ink container 71. A bottom surface of the cleaning liquid tray 73 includes an inclined surface 731 and a liquid collecting surface 732. The inclined surface 731 is a surface descending at a gentle slope from a right end side toward a left end side of the cleaning liquid tray 73. The liquid collecting surface 732 is a flat surface located near a left end of the cleaning liquid tray 73 and forming the deepest portion in the bottom surface. The left end edge of the inclined surface 731 is connected to the right end edge of the liquid collecting surface 732. A starting end of the relay passage 743 is open to the liquid collecting surface 732.

### Wiping Unit

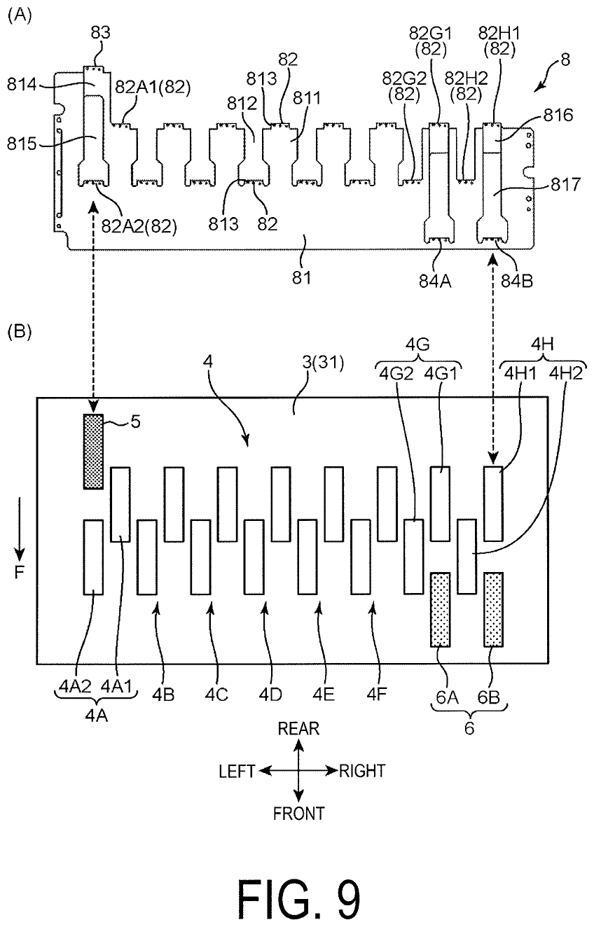

As illustrated in FIG. 7, the wiping unit 8 includes the wiper support plate 81, the ink wipers 82, the pre-processing liquid wiper 83 (processing liquid wiper), the post-processing liquid wiper 84 (processing liquid wiper), and a wiper driving portion 85. FIG. 9 is a view combining a plan view (region A) of the wiper support plate 81 holding the wipers 82, 83, and 84 and a plan view (region B) illustrating the arrangement of the ink head 4, the pre-processing head 5, and the post-processing head 6 mounted on the carriage 3 and illustrating a correspondence with the wipers 82, 83, and 84, respectively. The arrangement of the heads 4, 5, and 6 illustrated in FIG. 9 (region B) is the same as that illustrated in FIG. 3.

The wiper support plate 81 is formed by punching a thin flat plate member, and includes a plurality of protruding plates 811 each having a strip shape. The plurality of protruding plates 811 protrude in the rearward direction, which is the movement direction during wiping. A recessed portion 812 recessed to the front side is formed between adjacent ones of the protruding plates 811. The ink wiper 82 wiping the nozzle array surface NA of the ink head 4 is mounted to an end edge (rear end) of the protruding plate 811 and an end edge of the recessed portion 812. The ink wiper 82 disposed at the end edge of the protruding plate 811 is for wiping the upstream-side head of the ink head 4 of each color, such as an ink wiper 82A1 disposed for the upstream-side head 4A1 of the first ink head 4A. On the other hand, the ink wiper 82 disposed at the end edge of the recessed portion 812 is for wiping the downstream-side head of the ink head 4 of each color, such as an ink wiper 82A2 disposed for the downstream-side head 4A2.

In the wiper support plate 81, a supporting region supporting the pre-processing liquid wiper 83 wiping the nozzle array surface NA of the pre-processing head 5 is disposed at a position protruding rearward in the movement direction during wiping compared to other regions of the wiper support plate 81. Specifically, a protruding piece 814 extends further rearward from the rear end of the protruding plate 811 located at the leftmost position. The pre-processing liquid wiper 83 is mounted to an end edge (rear end) of the protruding piece 814. A window portion 815 corresponding to the recessed portion 812 is provided on the front side of the protruding piece 814. As described above, the pre-processing liquid wiper 83 is disposed to be supported at a position in the wiper support plate 81 most protruding in the movement direction, so that the pre-processing liquid wiped by the pre-processing liquid wiper 83 during wiping is less likely to adhere to other portions of the wiper support plate 81.

As illustrated in FIG. 9 (region B), in the present embodiment, the pre-processing head 5 and the downstream-side head 4A2 of the first ink head 4A are disposed so as to entirely overlap each other in the movement direction (rearward direction) during wiping. That is, the pre-processing head 5 and the downstream-side head 4A2 are disposed side by side on the upstream side and on the downstream side, respectively, in the conveyance direction F at the same position in the left-right direction of the head support frame 31. With such an arrangement, the path through which the ink wiper 82A2 passes from a wiping region toward the cleaning unit 9 overlaps the path wiped by the pre-processing liquid wiper 83. Thus, a risk of the pre-processing liquid dripping onto the ink wiper 82A2 and generating an aggregation can be reduced. The pre-processing head 5 and the downstream-side head 4A2 are desirably disposed in a positional relationship of completely overlapping each other in the movement direction during wiping, but may be disposed to be slightly shifted from each other in the left-right direction.

The right end side of the wiper support plate 81 is a support region supporting the post-processing liquid wiper 84 wiping the nozzle array surface NA of the post-processing head 6. Near the right end of the head support frame 31, two post-processing heads 6A and 6B are disposed side by side in the main scanning direction. The post-processing head 6A on the left side and the post-processing head 6B on the right side are disposed side by side with an upstream-side head 4G1 of a seventh ink head 4G and an upstream-side head 4H1 of an eighth ink head 4H on the upstream side and the downstream side, respectively, in the conveyance direction F.

Corresponding to such a head arrangement, the wiper support plate 81 is provided with a pair of holding pieces 816 and window portions 817 near the right end of the wiper support plate 81. The holding pieces 816 support ink wipers 82G1 and 82H1 wiping the upstream-side heads 4G1 and 4H1 at the rear end edges of the holding pieces 816, respectively. Ink wipers 82G2 and 82H2 wiping the downstream-side heads 4G2 and 4H2, respectively, are supported at the end edges of the recessed portions 812 adjacent to the left sides of the holding pieces 816, respectively. The window portions 817 are openings disposed in front of the holding pieces 816, respectively. At opening edges of the window portions 817 on the front side, the post-processing liquid wipers 84 (84A and 84B) wiping the post-processing heads 6A and 6B, respectively, are supported.

The wiper support plate 81 includes a plurality of protruding portions 813 disposed so as to correspond to the above-described wipers 82, 83, and 84, respectively. Each of the protruding portions 813 is successively provided to the rear end of the protruding plate 811, the base end edge of the recessed portion 812, the rear end of the protruding piece 814, and the base end edge of the window portion 817, respectively. Each of these protruding portions 813 is a small protrusion protruding toward the movement direction during wiping in the shape in a top surface view. The wipers 82, 83, and 84 are disposed on corresponding ones of the protrusions 813. With such an arrangement, the inks and the processing liquids adhering to the wipers 82, and 83 and 84, respectively, can be made difficult to adhere to the wiper support plate 81.

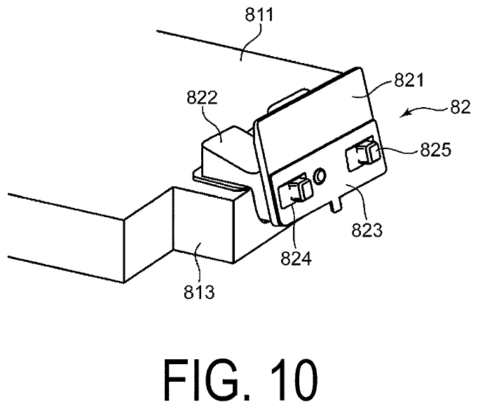

FIG. 10 is a perspective view illustrating a detailed structure of the ink wiper 82. The pre-processing liquid wiper 83 and the post-processing liquid wiper 84 also have a structure the same as, and/or similar to, the ink wiper 82 illustrated here. The ink wiper 82 includes a wiper blade 821 (ink blade or processing liquid blade), a first holder 822, and a second holder 823.

The wiper blade 821 is a plate member actually coming into contact with the nozzle array surface NA to perform the wiping operation. The upper end of the wiper blade 821 is located at a position protruding upward from the upper surface of the wiper support plate 81. The first holder 822 and the second holder 823 are members sandwiching and holding the wiper blade 821 therebetween. The first holder 822 is fitted into a recessed portion provided in the protruding portion 813 and fixed by screws, and supports a lower portion of a back surface of the wiper blade 821. The second holder 823 is attached to a lower portion of a front surface of the wiper blade 821.

The second holder 823 includes a pair of openings 824, and the wiper blade 821 also includes through holes at the same positions as the openings 824, respectively. On the other hand, the first holder 822 includes a pair of claw portions 825. The claw portions 825 are inserted into the through holes and the openings 824, and lock the second holder 823 at the peripheral edge of the openings 824. With this locking force, the wiper blade 821 is held between the first holder 822 and the second holder 823. The wiper blade 821 is held at a position further protruding from a protruding end surface of the protruding portion 813.

The pre-processing liquid wiper 83 and the post-processing liquid wiper 84 may be configured to have the same structure, shape, and material as the ink wiper 82 illustrated in FIG. 10, or may be differently configured from the above. For example, the shape and material of the wiper blade 821 and the support structure of the wiper blade 821 may be different from the ink wiper 82 with respect to the pre-processing liquid wiper 83 and/or the post-processing liquid wiper 84 in accordance with the properties of the ink and/or the processing liquid. As the wiper blade 821, a blade made of a rubber or a resin material having a predetermined rigidity is used. For example, a case is assumed in which the pre-processing liquid has a property of drying faster than the ink and is relatively difficult to be wiped. In this case, the wiping force of the wiper blade 821 is desirably enhanced using, as the wiper blade 821 of the pre-processing liquid wiper 83, a blade having higher rigidity than that of the ink wiper 82, or increasing the protruding height of the wiper blade 821.

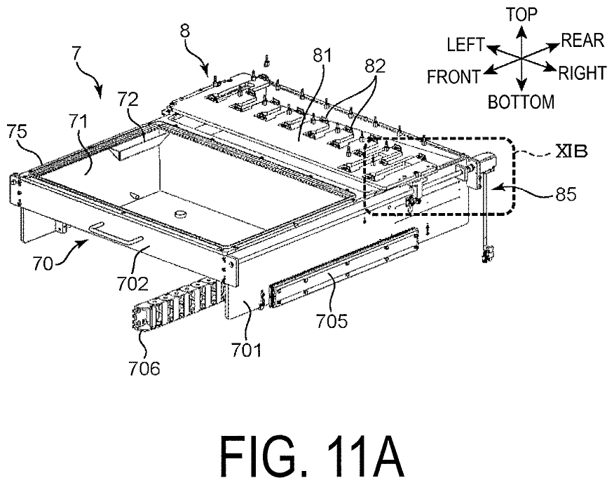

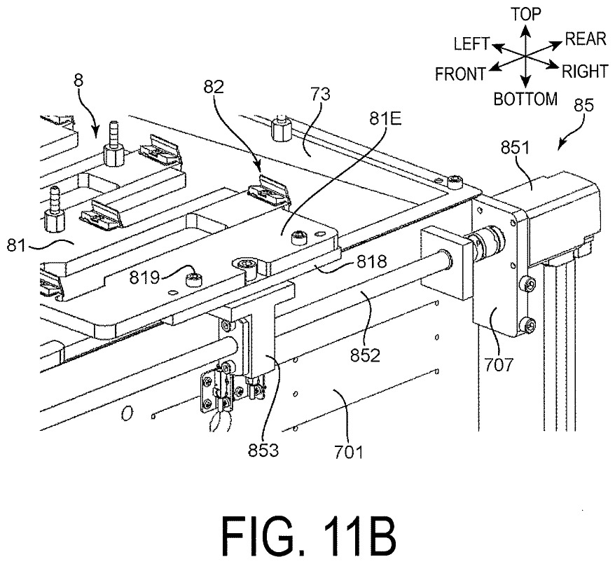

FIG. 11A is a perspective view of the maintenance unit 7 with a perspective direction different from that in FIG. 7, and is a view for explaining the wiper driving portion 85. FIG. 11B is an enlarged view of an XIB portion surrounded by a dotted line in FIG. 11A. The wiper driving portion 85 is a mechanism moving the wiper support plate 81 holding the wipers 82, 83, and 84 in the front-rear direction. The wiper driving portion 85 includes a servomotor 851, a ball screw 852, and a slider 853. The servomotor 851 is a motor corresponding to the wiper-moving motor 36 illustrated in FIG. 5.

The servomotor 851 generates a driving force moving the wiper support plate 81. The servomotor 851 is mounted on the right end of a rear plate 707 of the container unit 70. The ball screw 852 is rotationally driven normally or reversely around the shaft by the servomotor 851. The ball screw 852 extends in the front-rear direction along the side frame 701 on the right side. A guide bar (not illustrated) extending in the front-rear direction is attached to the side frame 701 on the left side. The slider 853 contains a nut member screwed to the ball screw 852. When the ball screw 852 is rotated normally or reversely, the slider 853 moves forward and backward in the front-rear direction, respectively, along the ball screw 852.

The slider 853 is connected to the wiper support plate 81. A connecting plate 818 made of an elongated flat plate member is mounted on the upper portion of the slider 853. An end portion 81E on the right side of the wiper support plate 81 is placed on the connecting plate 818, and the connecting plate 818 and the end portion 81E are fastened together by a fixing screw 819. Although not illustrated, an end portion on the left side of the wiper support plate 81 is also supported by members equivalent to the coupling plate 818 and the slider 853, and is guided along the guide bar.

A movement range of the wiper support plate 81 is between a front end (wiping area) and a rear end (cleaning area) of the container unit 70. For example, when the servomotor 851 is rotationally driven normally by the controller 33, the slider 853 is fed in the forward direction, and the wiper support plate 81 fixed to the slider 853 also moves in the forward direction. On the other hand, when the servomotor 851 is rotationally driven reversely, the wiper support plate 81 moves in the rearward direction.

As the wiper support plate 81 moves as described above, the ink container 71 can receive the ink falling from the ink head 4 during wiping by the ink wiper 82 through the first opening 71H. Further, the ink container 71 can receive the ink falling from the post-processing head 6 during wiping by the post-processing liquid wiper 84 through the first opening 71H. On the other hand, the pre-processing liquid container 72 can receive the processing liquid falling from the pre-processing head 5 during wiping by the pre-processing liquid wiper 83 through the second opening 72H.

In the present embodiment, as described above, the container unit 70 and the wiping unit 8 are capable of being integrally pulled out from the apparatus frame 10 (housing). At this time, the pull-out direction of the wiping unit 8 is a direction along the movement direction when each wiper wipes a respective one of heads. Thus, when the wiping unit 8 is taken in and out, a direction of an acceleration applied to the liquid adhering to each wiper is along the movement direction of the wiper, and thus the liquid adhering to each wiper can be reduced to adhere to the wiper support plate 81.

### Cleaning Unit

Referring to FIG. 6, the cleaning unit 9 includes the nozzle holding plate 91 and the plurality of cleaning nozzles 92. The nozzle holding plate 91 is a U-shaped frame member including a top plate 911 (top plate portion) and a pair of left and right side plates 912. The top plate 911 is a flat plate having a width slightly larger than a left-right width of the container unit 70. The pair of side plates 912 are flat plates hanging down from the left end and the right end, respectively, of the top plate 911, and face the left and right side frames 701, respectively.

The nozzle holding plate 91 is fixed at an appropriate position on the apparatus frame 10 (FIG. 1). In a state where the container unit 70 is loaded at a predetermined position on the apparatus frame 10, the nozzle holding plate 91 is in a positional relationship of being fitted into a rear region of the container unit 70 from above. A portion where the nozzle holding plate 91 covers the container unit 70 serves as a cleaning area for cleaning the ink wipers 82, the pre-processing liquid wiper 83, and the post-processing liquid wiper 84. The top plate 911 faces the cleaning liquid tray 73 of the container unit 70 in the up-down direction with a predetermined gap therebetween. The gap has an up-down width allowing the wiping unit 8 to enter between the top plate 911 and the cleaning liquid tray 73. In the present embodiment, the cleaning liquid tray 73 is pulled out together with the container unit 70 while leaving the cleaning unit 9, and thus cleaning of the cleaning liquid tray 73 is further easily realized.

The plurality of cleaning nozzles 92 are disposed at appropriate positions on the top plate 911 so as to match the arrangement of the wipers 82, 83, and 84 on the wiper support plate 81. The plurality of cleaning nozzles 92 include nozzles 92A cleaning the ink wipers 82, a nozzle 92B cleaning the pre-processing liquid wiper 83, and a nozzle 92C cleaning the post-processing liquid wiper 84. The nozzles 92A, 92B, and 92C eject the cleaning liquid 9A in the fan-shaped spray form from the lower end surfaces thereof (see FIG. 4), to clean the wipers 82, 83, and 84, respectively.

### Movement Path during Wiping Operation

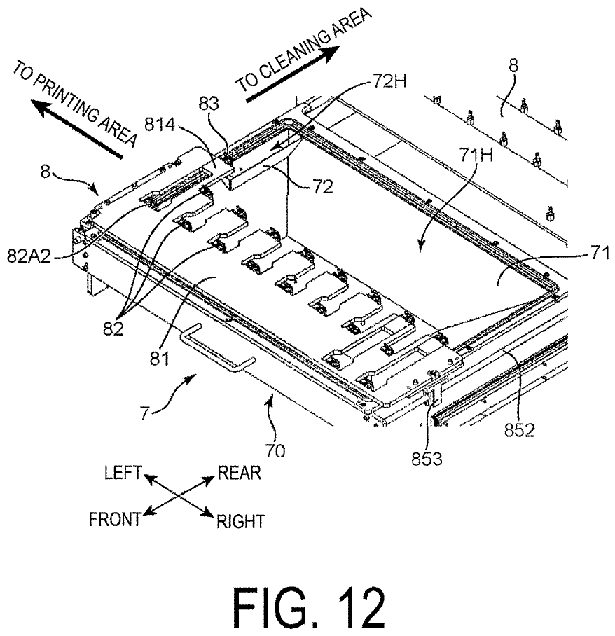

Next, a movement path of the wiping unit 8 during wiping including a positional relationship with respect to peripheral members will be described. FIG. 12 is a perspective view illustrating an initial position of the wiping unit 8 during wiping. During wiping, the wiping unit 8 moves from the initial position toward the rear toward the cleaning area where the cleaning unit 9 is disposed. An area above the first opening 71H of the ink container 71 and the second opening 72H of the pre-processing liquid container 72 serves as the wiping area where the wipers 82, 83, and 84 wipe the heads 4, 5, and 6, respectively.

To the left of the maintenance unit 7, there is the printing area 12 (FIG. 1) where an ink is ejected from the ink head 4 to form an image. For this reason, when the carriage 3 temporarily stops in the maintenance area 13, the carriage 3 enters the maintenance area 13 from the left side of the maintenance unit 7. As illustrated in FIG. 9, the pre-processing head 5 is supported by the carriage 3 at the leftmost position side by side with the downstream-side head 4A2 of the first ink head 4A. In line with this, the pre-processing liquid wiper 83 is also disposed at the leftmost position in the wiper support plate 81.

That is, in the movement direction in which the carriage 3 moves from the printing area 12 to the wiping area, the pre-processing liquid wiper 83 is disposed at a position closer to the printing area 12 than the other ink wipers 82 except for the ink wiper 82A2 for the downstream-side head 4A2. According to this arrangement, the pre-processing liquid container 72 is naturally disposed near the left end of the ink container 71. In this case, an arrangement in which the pre-processing head 5 does not pass through the first opening 71H of the ink container 71 at the time of the temporary stop can be realized. This makes it difficult for the pre-processing liquid adhering to the pre-processing head 5 to drip into the ink container 71.

The arrangement of the pre-processing liquid container 72 also provides the above-described effect. That is, in the present embodiment, in the movement direction in which the carriage 3 including the pre-processing head 5 moves from the printing area to the wiping area, the pre-processing liquid container 72 is disposed at a position closer to the printing area than the ink container 71. Thus, on the assumption that the pre-processing liquid wiper 83 wipes the pre-processing head 5 on the pre-processing liquid container 72, the pre-processing head 5 enters deep into the wiping area, and adhesion of the pre-processing liquid, which has adhered to the pre-processing head 5, to the ink container 71 or the like can be reduced.

In the movement direction from the wiping area to the cleaning area, the pre-processing liquid wiper 83 is supported by the wiper support plate 81 at the position closest to the cleaning area among the wipers 82, 83, and 84. That is, as illustrated in FIG. 9 (region A), the pre-processing liquid wiper 83 is disposed at the end edge of the protruding piece 814 protruding most rearward in a top surface view in the wiper support plate 81. Thus, the pre-processing liquid wiper 83 can be introduced into the cleaning area most quickly to apply the cleaning processing. For example, in a case where the pre-processing liquid has a quick-drying property, if the nozzle 92B (FIG. 6) cleaning the pre-processing liquid wiper 83 is disposed on the frontmost side of the nozzle holding plate 91, the pre-processing liquid wiper 83 can be immediately cleaned.

The arrangement of the pre-processing liquid container 72 also provides the above-described effect. That is, in the present embodiment, the entirety of the pre-processing liquid container 72 is disposed at a position closer to the cleaning area (cleaning unit 9, cleaning portion) than the entirety of the ink container 71. Thus, under the assumption that the pre-processing liquid wiper 83 wipes the pre-processing head 5 on the pre-processing liquid container 72, the pre-processing liquid wiper 83 can be quickly cleaned. The pre-processing liquid container 72 may be disposed so as to protrude further toward the cleaning area side than the ink container 71.

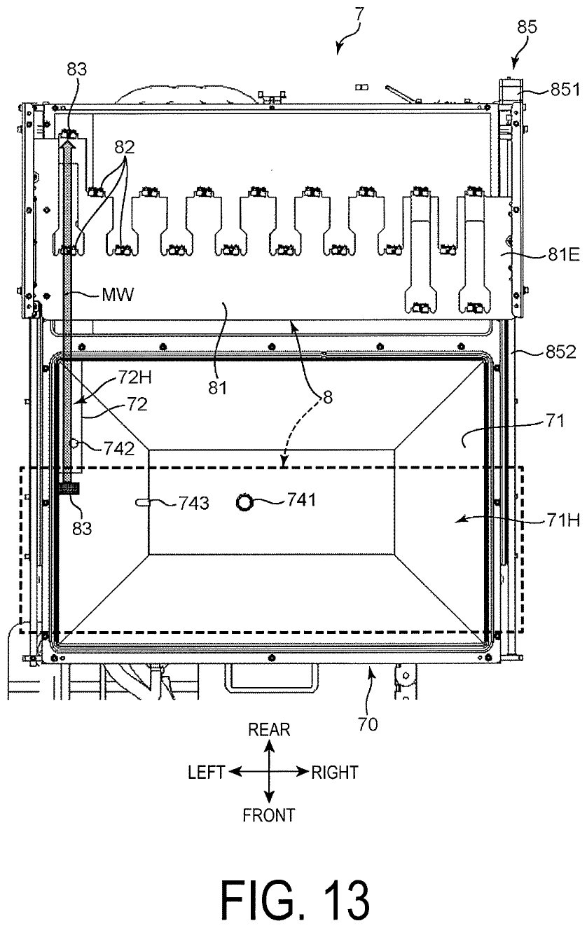

FIG. 13 is a top view of the maintenance unit 7 illustrating a movement path MW of the wiping unit 8 during wiping. A position indicated by a dotted line in the drawing is an initial position of the wiping unit 8 and the pre-processing liquid wiper 83 during wiping. In FIG. 13, a position of the wiping unit 8 indicated by a solid line is a wiping completion position where the wipers 82, 83, and 84 are cleaned, and a standby position waiting for an instruction for executing the wiping operation.

In the present embodiment, the movement path MW (movement range) of the pre-processing liquid wiper 83 during wiping is set to a position without a region directly above the first opening 71H of the ink container 71. In other words, the first opening 71H of the ink container 71 is disposed at a position without a region directly below the movement path MW of the pre-processing liquid wiper 83. Specifically, the movement range when the pre-processing liquid wiper 83 performs the wiping operation in the wiping area is set directly above the second opening 72H of the pre-processing liquid container 72. In other words, the first opening 71H is practically not located directly below a region where the pre-processing liquid wiper 83 wipes the nozzle array surface NA of the pre-processing head 5, and most or all of the region faces the second opening 72H in the up-down direction. To put it another way, the first opening 71H of the ink container 71 is disposed at a position other than the entire movement path MW of the pre-processing liquid wiper 83 when viewed from above. With this arrangement, the likelihood of the pre-processing liquid wiped by the pre-processing liquid wiper 83 during wiping mixing into the ink container 71 through the first opening 71H can be reduced. Thus, an occurrence of a chemical reaction such as the aggregation of the ink can be suppressed.

When the ink container 71 and the pre-processing liquid container 72 are viewed in the direction along the movement path MW (front-rear direction), it can be said that a part of the first opening 71H (left end front portion) and the second opening 72H are disposed in series (see FIG. 13). That is, a part of the first opening 71H is disposed on the front side and the second opening 72H is disposed on the rear side. An orientation direction of the movement path MW, that is, the movement direction of the pre-processing liquid wiper 83 is from the front side to the rear side. In other words, the movement direction of the pre-processing liquid wiper 83 is a direction away from the first opening 71H. Moreover, as illustrated in FIG. 8B, the rear end edge (rear wall 722) of the pre-processing liquid container 72 is flush with the rear end edge (tapered surface 712 on the rear side) of the ink container 71. In other words, the first opening 71H is not interposed between the rear end edge of the pre-processing liquid container 72 and the cleaning area in the movement path MW. Thus, the pre-processing liquid, which may be scattered when the pre-processing liquid wiper 83 finishes the wiping of the pre-processing head 5 and separates from the nozzle array surface NA, can be suppressed from entering the ink container 71.

The orientation direction of the movement path MW is a direction in which the cleaning area where the cleaning unit 9 is disposed is located. Such an arrangement also contributes to a measure against scattering of the pre-processing liquid. That is, when the pre-processing liquid wiper 83 separates from the nozzle array surface NA of the pre-processing head 5, even if the pre-processing liquid adhering to the pre-processing liquid wiper 83 is scattered, the scattering destination of the pre-processing liquid is the cleaning area. In the cleaning area, the scattered pre-processing liquid is diluted with a relatively large amount of cleaning liquid and is collected by the cleaning liquid tray 73. Thus, an operation can be realized in which droplets of the pre-processing liquid are unlikely to enter the ink container 71.

### Position Avoiding Position Immediately Above First Opening

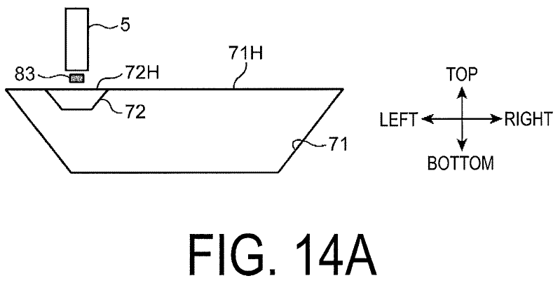

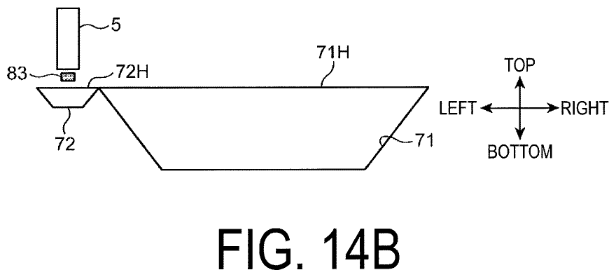

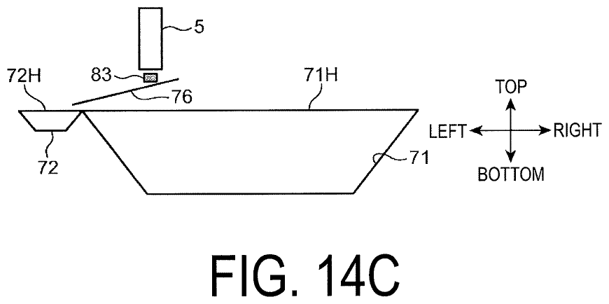

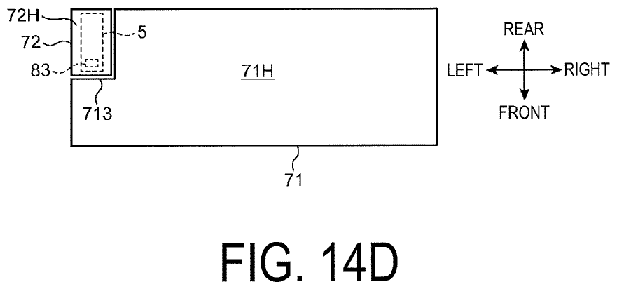

Variations of the above-described “position without a region directly above the first opening 71H” will be described. FIGS. 14A to 14D are schematic views illustrating various arrangement examples of the pre-processing liquid container 72 without a region directly above the first opening 71H of the ink container 71. FIGS. 14A, 14B, and 14C are schematic cross-sectional views of the maintenance unit 7 in the left-right direction, and FIG. 14D is a top view. The “position without a region directly above” includes a position where another member is interposed between a partial region of the first opening 71H and the pre-processing liquid wiper 83 in addition to a case where the position is out of an upper space of the first opening 71H.

FIG. 14A illustrates an example in which the movement range of the pre-processing liquid wiper 83 is set to a position without a region directly above the first opening 71H by disposing the pre-processing liquid container 72 at a position covering a part of the first opening 71H. The example in FIG. 14A is the same as or similar to, the example illustrated in FIG. 8A described above. In this example, the “position without a region directly above the first opening 71H” is achieved by disposing the second opening 72H of the pre-processing liquid container 72 below the movement range of the pre-processing liquid wiper 83 while the movement range of the pre-processing liquid wiper 83 is set to be above the first opening 71H.

FIG. 14B illustrates an example in which the movement range of the pre-processing liquid wiper 83 is simply set to a position out of the upper space of the first opening 71H. In this example, the pre-processing liquid container 72 is naturally disposed at a position not overlapping the first opening 71H in the up-down direction. FIG. 14C illustrates an example in which another member is interposed between the first opening 71H and the pre-processing liquid wiper 83. The pre-processing liquid container 72 is disposed adjacent to the ink container 71. On the other hand, the pre-processing liquid wiper 83 is located above the first opening 71H in order to wipe the pre-processing head 5 disposed above the first opening 71H.

A guide plate 76 is disposed below the pre-processing liquid wiper 83 in a downward inclining manner in a direction toward the second opening 72H. The pre-processing liquid wiped from the pre-processing head 5 by the pre-processing liquid wiper 83 is guided to the second opening 72H through the guide plate 76.

FIG. 14D illustrates an example in which the “position without a region directly above the first opening 71H” is achieved by devising the shape of the ink container 71. The ink container 71 includes a notch portion 713 at a position corresponding to the lower side of the arrangement region of the pre-processing head 5. Thus, the movement range of the pre-processing liquid wiper 83 is out of the first opening 71H. The pre-processing liquid container 72 is disposed in the notch portion 713.

In other words, for each of the above examples, it can be said that in these examples, the first opening 71H of the ink container 71 is set to the position without the position directly below the entirety of the movement path of the pre-processing liquid wiper 83. In either case, the pre-processing liquid can be suppressed from entering the ink container 71 along with the movement of the pre-processing liquid wiper 83. The “position without the position directly below” includes a diagonally downward position and a position where another member is interposed between a partial region of the first opening 71H and the pre-processing liquid wiper 83 in addition to a case where the first opening 71H of the ink container 71 is out of a lower space of the movement path of the pre-processing liquid wiper 83.

### Positional Relationship between Movement Range and Second Opening

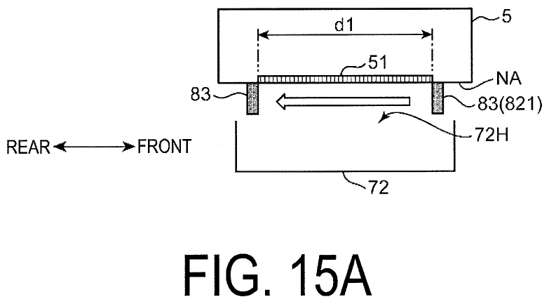

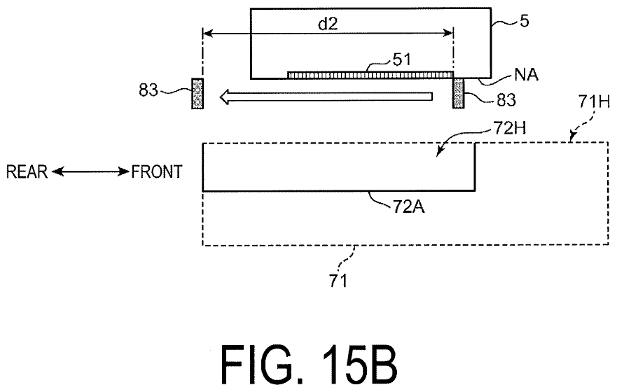

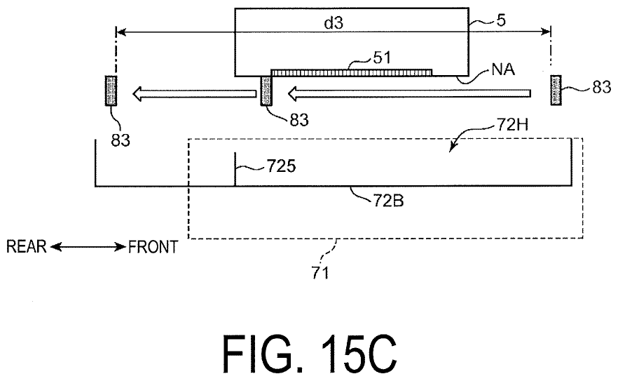

Next, a positional relationship between the movement range of the pre-processing liquid wiper 83 and the second opening 72H of the pre-processing liquid container 72 will be described. FIGS. 15A, 15B, and 15C are schematic views for explaining the movement range of the pre-processing liquid wiper 83 during the wiping operation. FIG. 15A illustrates an actual wiping range d1 in which the pre-processing liquid wiper 83 substantially performs the wiping operation. The actual wiping range d1 corresponds to the width of a nozzle array portion 51 in which a large number of nozzles ejecting the pre-processing liquid are arrayed in the pre-processing head 5. That is, in the movement direction of the pre-processing liquid wiper 83, d1 is a length from the upstream end (front end) to the downstream end (rear end) of the nozzle array portion 51. The nozzle array portion 51 is a portion to which the pre-processing liquid actually adheres. Thus, a span in which the pre-processing liquid wiper 83 (wiper blade 821) moves in the actual wiping range d1 serves as a section in which the pre-processing liquid wiper 83 substantially performs a task of wiping the pre-processing liquid. When the wiping is performed, the wiped pre-processing liquid drips from the wiper blade 821 along the second holder 823 (see FIG. 10). The dripping pre-processing liquid is received by the pre-processing liquid container 72.

FIG. 15A illustrates an example in which the pre-processing liquid container 72 including the second opening 72H having a front-rear width covering the actual wiping range d1 and a thickness of the pre-processing liquid wiper 83 before and after the actual wiping range d1 is disposed below the pre-processing head 5. When the second opening 72H is disposed in such a range, at least a region where the pre-processing liquid is most likely to drip can be covered, and thus the likelihood of the pre-processing liquid mixing into the ink container 71 can be significantly reduced. Instead of the example illustrated in FIG. 15A, the second opening 72H may have a size equal to or slightly larger than the actual wiping range d1.

FIG. 15B illustrates a container area range d2 from a start position of the actual wiping of the pre-processing liquid wiper 83 until the pre-processing liquid wiper 83 exits the wiping area. The start position of the actual wiping is the upstream end of the nozzle array portion 51 as in FIG. 15A. The wiping area is a range covered by the first opening 71H of the ink container 71 in the present embodiment, and thus the position exiting the wiping area is the rear end edge of the first opening 71H. FIG. 15B illustrates an example in which the pre-processing liquid container 72A including the second opening 72H covering such a container area range d2 is disposed below the pre-processing head 5. When the second opening 72H is disposed corresponding to the container area range d2, the pre-processing liquid dripping from the pre-processing liquid wiper 83 during a period between completion of the actual wiping and while going toward the cleaning area can be collected by the pre-processing liquid container 72A.

FIG. 15C illustrates an entire range d3 of the predetermined movement path MW (FIG. 13) in which the pre-processing liquid wiper 83 moves when executing wiping. A rear end of the movement path MW is the standby position and an operation completion position of the pre-processing liquid wiper 83. A front end of the movement path MW is a position where the pre-processing liquid wiper 83 moves most forward in a series of wiping operations. That is, during the wiping operation, the pre-processing liquid wiper 83 advances and moves from the rear end to the front end of the movement path MW, and returns from the front end to the rear end of the movement path MW after the carriage 3 descends and the nozzle array surface NA reaches a predetermined wiping height. Here, an example is illustrated in which the front end of the movement path MW is on the front side of the pre-processing head 5, but the front end of the movement path MW may be between the front end edge of the pre-processing head 5 and the upstream end of the nozzle array portion 51.

In FIG. 15C, an example is illustrated in which a pre-processing liquid container 72B including the second opening 72H covering the entire range d3 is disposed below the pre-processing head 5. In this case, the entirety of the movement path MW is set to the position without a region directly above the first opening 71H. When the second opening 72H is disposed corresponding to such a range d3, the pre-processing liquid can be more reliably collected by the pre-processing liquid container 72B. The pre-processing liquid container 72B includes a partition plate 725 at a boundary position between the wiping area and the cleaning area. A rear portion of the pre-processing liquid container 72B enters the cleaning area. By providing the partition plate 725, the pre-processing liquid collected in the wiping area can be isolated and collected through an independent path.

### Removal Portion of Ink Wiper

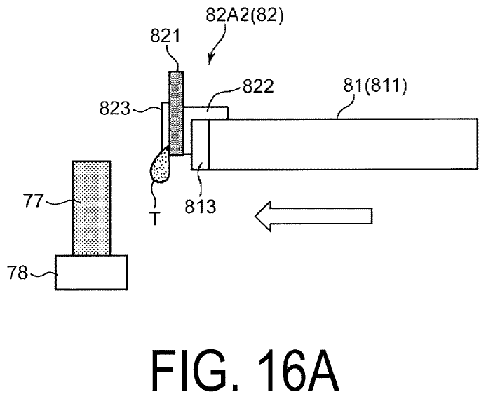

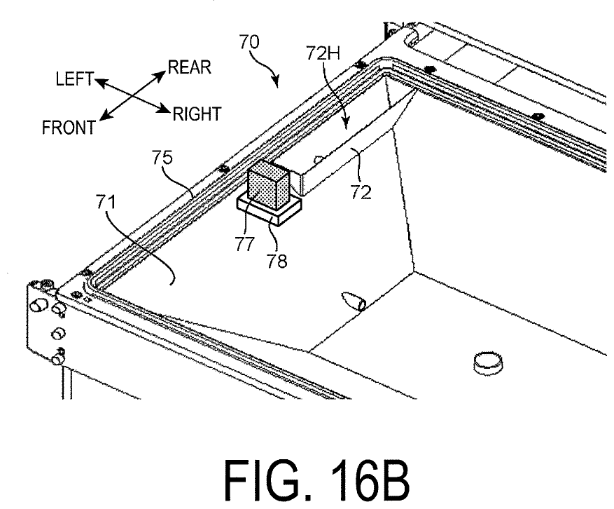

Among the plurality of ink wipers 82 included in the wiping unit 8, the ink wiper 82A2 (FIG. 9) disposed for the downstream-side head 4A2 located on the leftmost side passes over the second opening 72H of the pre-processing liquid container 72 when the wiping unit 8 moves toward the cleaning area. When passing, the ink adhering to the ink wiper 82A2 may drip into the pre-processing liquid container 72 and cause aggregation or the like. Examples of how to deal with this problem are illustrated in FIG. 16A and FIG. 16B.

FIG. 16A is a schematic side view illustrating the periphery of the ink wiper 82A2. The wiper blade 821 of the ink wiper 82A2 is supported by the protruding portion 813 of the wiper support plate 81 while being held by the first holder 822 and the second holder 823. When the ink wiper 82A2 wipes the downstream-side head 4A2 of the first ink head 4A, the wiped ink or the like may remain as adhering matter T in a state where the wiped ink does not completely fall from the lower end of the ink wiper 82A2. A sponge 77 (removal portion) is desirably disposed in order to reduce the adhering matter T before the second opening 72H of the pre-processing liquid container 72.

FIG. 16B is a main portion perspective view of the container unit 70 illustrating an arrangement of the sponge 77 illustrated in 16A. In the present embodiment, in the movement direction of the ink wiper 82A2 to the cleaning area, the second opening 72H is disposed on the downstream side of the first opening 71H. The sponge 77 is disposed at a height position at which the sponge 77 comes into contact with the lower end surface of the ink wiper 82A2 and on the upstream side of the second opening 72H. A support plate 78 is provided to protrude near the upper end of the tapered surface 712 on the left side of the ink container 71 and on the upstream side of the second opening 72H. The lower end of the sponge 77 is fixed to the upper surface of the support plate 78. The adhering matter T containing the ink is removed by the sponge 77 before the ink wiper 82A2 reaches the second opening 72H. Thus, the ink can be suppressed from mixing into the pre-processing liquid container 72.

### Inclined Arrangement of Wiper

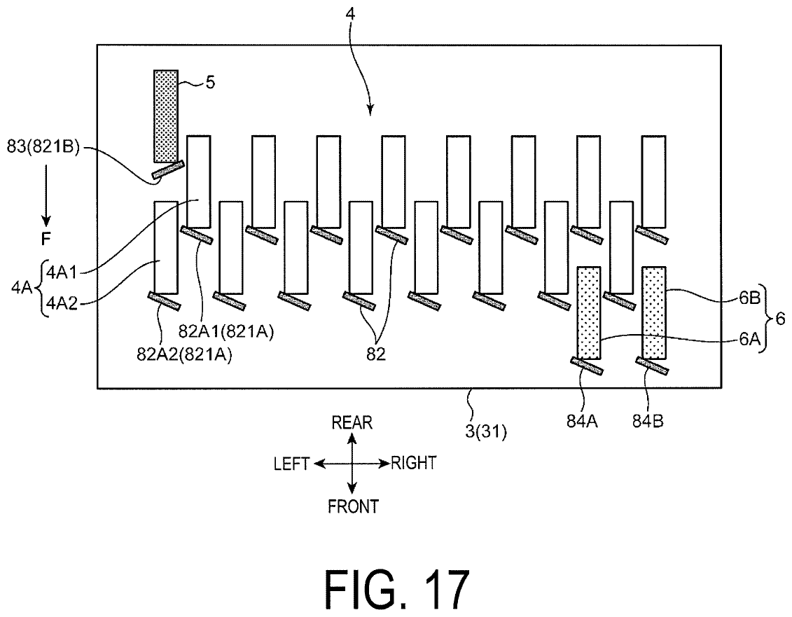

Next, a preferred arrangement example of the ink wipers 82 and the pre-processing liquid wiper 83 will be described. FIG. 17 is a plan view illustrating an inclined arrangement of the ink wipers 82 and the pre-processing liquid wiper 83. As illustrated in FIG. 10, the ink wipers 82 includes a wiper blade 821A (ink blade) extending in a direction (left-right direction) intersecting the movement direction (front-rear direction) during wiping. Similarly, the pre-processing liquid wiper 83 also includes a wiper blade 821B (processing liquid blade) extending in the left-right direction.

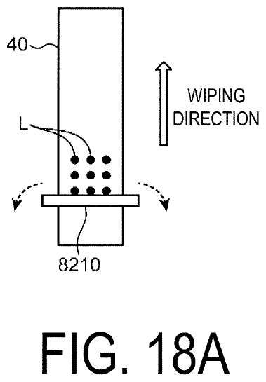

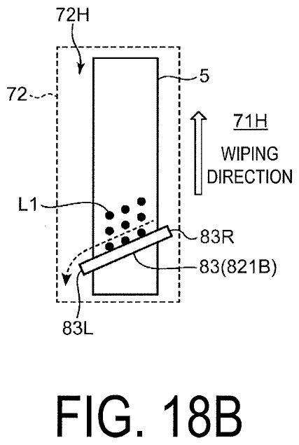

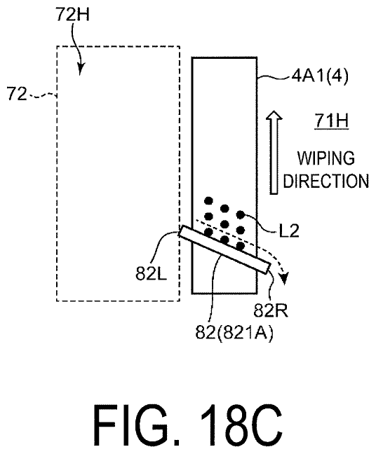

In the movement direction of the ink wiper 82 during wiping, the wiper blade 821A of the ink wiper 82 is disposed to be inclined such that a left end portion side of the wiper blade 821A protrudes compared to a right end portion side. Attention is paid to the ink wiper 82A1 wiping the upstream-side head 4A1 of the first ink head 4A located to the right of the pre-processing head 5. As also illustrated in FIG. 18C, the wiper blade 821A of the ink wiper 82A1 is disposed to be inclined such that a left end portion 82L (first end) on a side where the pre-processing liquid container 72 is present protrudes in the movement direction compared to a right end portion 82R (second end) on the opposite side thereof. The post-processing liquid wipers 84A and 84B wiping the post-processing heads 6A and 6B, respectively, are also disposed to be inclined such that the left end portions protrude in the movement direction of the post-processing liquid wipers 84A and 84B compared to the right end portions.

On the other hand, in the movement direction of the pre-processing liquid wiper 83, the wiper blade 821B of the pre-processing liquid wiper 83 is disposed to be inclined such that the right end portion side protrudes compared to the left end portion side. Referring also to FIG. 18B, the wiper blade 821B of the pre-processing liquid wiper 83 is disposed to be inclined such that a right end portion 83R (third end portion) on a side where the first opening 71H of the ink container 71 is present on the right protrudes in the movement direction compared to a left end portion 83L (fourth end portion) on the opposite side thereof.

FIG. 18A is a view illustrating a wiping state of a head 40 by a wiper blade 8210 having no inclination. The liquid L adheres to the head 40. The wiper blade 8210 is disposed so as to extend in a direction orthogonal to the wiping direction. When wiping is performed by such a wiper blade 8210, the liquid L wiped from the head 40 drips from the right and left of the head 40 as indicated by arrows in the drawing. For example, when the wiper blade 8210 is applied to the pre-processing liquid wiper 83, the pre-processing liquid dripping from the right side of the pre-processing head 5 may mix into the ink container 71. In addition, when the wiper blade 8210 is applied to the upstream-side head 4A of the first ink head 4A1, the ink dripping from the left side of the upstream-side head 4A1 may mix into the pre-processing liquid container 72.

FIG. 18B is a view illustrating a wiping state of the pre-processing head 5 by the pre-processing liquid wiper 83 including the wiper blade 821B having an inclination. The wiper blade 821B has an inclination such that the right end portion 83R protrudes in the wiping direction. Thus, the pre-processing liquid L1 wiped from the pre-processing head 5 by the wiper blade 821B drips only from the left side of the pre-processing head 5. Thus, the likelihood of the pre-processing liquid LI dripping into the first opening 71H of the ink container 71 adjacent to the right side of the second opening 72H of the pre-processing liquid container 72 can be reduced.

FIG. 18C is a view illustrating a wiping state of the ink head 4 (upstream-side head 4A1) by the ink wiper 82 including the wiper blade 821A having an inclination. The wiper blade 821A has an inclination such that the left end portion 82L protrudes in the wiping direction. Thus, an ink L2 wiped from the upstream-side head 4A1 by the wiper blade 821A drips only from the right side of the upstream-side head 4A1. Thus, the likelihood of the ink L2 dripping into the second opening 72H during wiping can be reduced.

According to the embodiment illustrated in FIGS. 17, 18B, and 18C, dripping destinations of the pre-processing liquid L1 and the ink L2 wiped by wiping can be controlled by the inclined arrangements of the wiper blades 821A and 821B, respectively. Thus, the likelihood of the pre-processing liquid L1 and the ink L2 being mixed with each other in the ink container 71 or the pre-processing liquid container 72 can be reduced. When the inclined arrangement of the wiper blades 821A and 821B can prevent the pre-processing liquid L1 and the ink L2 from being mixed with each other, a part or the entirety of the movement range of the pre-processing liquid wiper 83 during wiping may be set directly above the first opening 71H.

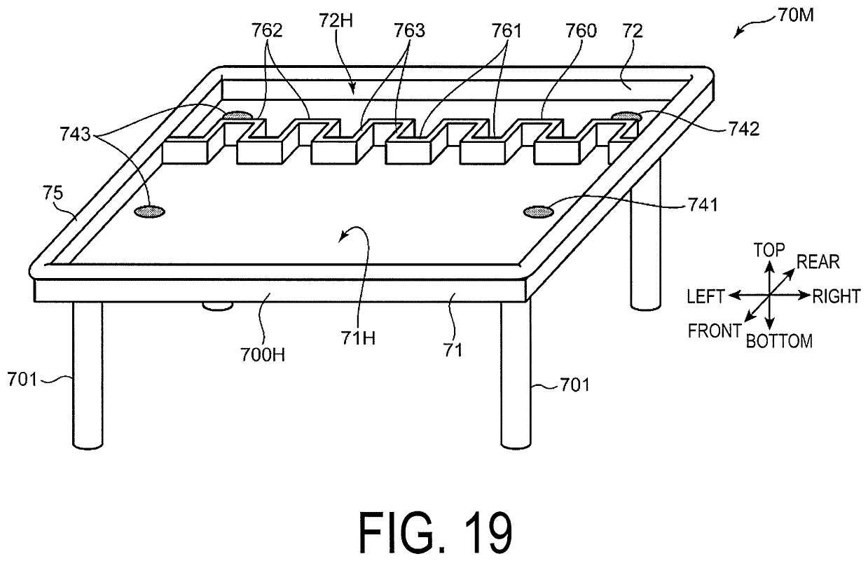

FIG. 19 is a perspective view of a container unit 70M (container) according to a first variation embodiment of the present disclosure. In the present variation embodiment, members having the same functions as those in the previous embodiment are denoted by the same reference numerals as those in FIGS. 1 to 18. The same applies to other variation embodiments described below.

The container unit 70M includes the container main body 700H, a plurality of the side frames 701, and a partition 760. As in the previous embodiment, above the container unit 70M, the ink head 4 ejecting the ink (liquid), the pre-processing head 5 ejecting the pre-processing liquid (liquid), and the post-processing head 6 ejecting the post-processing liquid (liquid) are supported by the carriage 3.

The container main body 700H has a rectangular shape in a plan view and includes, at an upper surface portion thereof, an opening receiving the liquid ejected from the above-described plurality of heads. The partition 760 partitions the container main body 700H into a plurality of independent regions.

Specifically, in the present variation embodiment, as illustrated in FIG. 19, the partition 760 partitions the container main body 700H into two regions of front and rear. The ink container 71 (ink container portion) is formed on the front side of the partition 760, and the pre-processing liquid container 72 (processing liquid container portion) is formed on the rear side of the partition 760. The ink container 71 includes the first opening 71H receiving the ink ejected from the ink head 4, and the pre-processing liquid container 72 includes the second opening 72H receiving the pre-processing liquid (the other processing liquid) ejected from the pre-processing head 5. As in the previous embodiment, the first opening 71H of the ink container 71 also receives the post-processing liquid (one processing liquid) ejected from the post-processing head 6. The overflow passage 741 and the relay passage 743 described above are open in the ink container 71, and the processing liquid passage 742 (eject port) and the relay passage 743 (cleaning liquid supply portion) are open in the pre-processing liquid container 72. As a result, a cleaning liquid that has passed through the wiper flows into the ink container 71 and the pre-processing liquid container 72 from the cleaning liquid tray 73 (cleaning portion) (FIG. 8A), and the ink and the post-processing liquid mixed with the cleaning liquid or the pre-processing liquid are respectively ejected. Thus, the cleaning liquid can be effectively utilized, and the ink, the pre-processing liquid, and the post-processing liquid can be efficiently ejected by utilizing the fluidity of the cleaning liquid.

The partition 760 includes a plurality of lateral plates 761 and a plurality of lateral plates 762 (first portions), and a plurality of vertical plates 763 (second portions) connected to these lateral plates. Each lateral plate 761 and each lateral plate 762 partition the container main body 700H in the front-rear direction (first direction). On the other hand, each vertical plate 763 partitions the container main body 700H in the left-right direction (second direction intersecting the first direction). In the present variation embodiment, a direction partitioned by the lateral plates 761, the lateral plates 762, and the vertical plates 763 is a horizontal direction. As in a variation embodiment described below, one lateral plate and one vertical plate may be disposed.

As illustrated in FIG. 19, the partition 760 does not partition the container main body 700H in a linear fashion but in a two-dimensional fashion, and more specifically, in the periphery of the partition 760, a rear end portion of the ink container 71 and a front end portion of the pre-processing liquid container 72 are respectively disposed in a staggered manner. Thus, while the upstream-side heads 4A1 to 4H1 of the ink heads 4 in FIG. 9 (region B) can be disposed above the ink container 71 side of a space portion of the staggered shape corresponding to the ink container 71 side, the pre-processing head 5 can be disposed above the pre-processing liquid container 72 side corresponding to the pre-processing liquid container 72 side, and the degree of freedom in the arrangement of the ink heads 4 and the pre-processing head 5 can be increased as in FIG. 9 (region B). In the example in FIG. 19, the position of the pre-processing head 5 in FIG. 9 (region B) can be moved in the right direction between the adjacent ones of heads of the upstream-side heads 4A1 to 4H1. Further, a plurality of the pre-processing heads 5 may be disposed at these positions, respectively.

As described above, also in the present variation embodiment, the partition 760 partitions the container main body 700H of the container unit 70 along two directions, and thus a plurality of types of liquids which are desired to be prevented from being mixed with each other can be separately collected, and the degree of freedom in the arrangement of the corresponding heads can be further increased. The number of the lateral plates 761, the lateral plates 762, and the vertical plates 763 in FIG. 19 may be set as appropriate in accordance with the arrangement and number of heads as illustrated in FIG. 9 (region B). The same applies to variation embodiments described below.

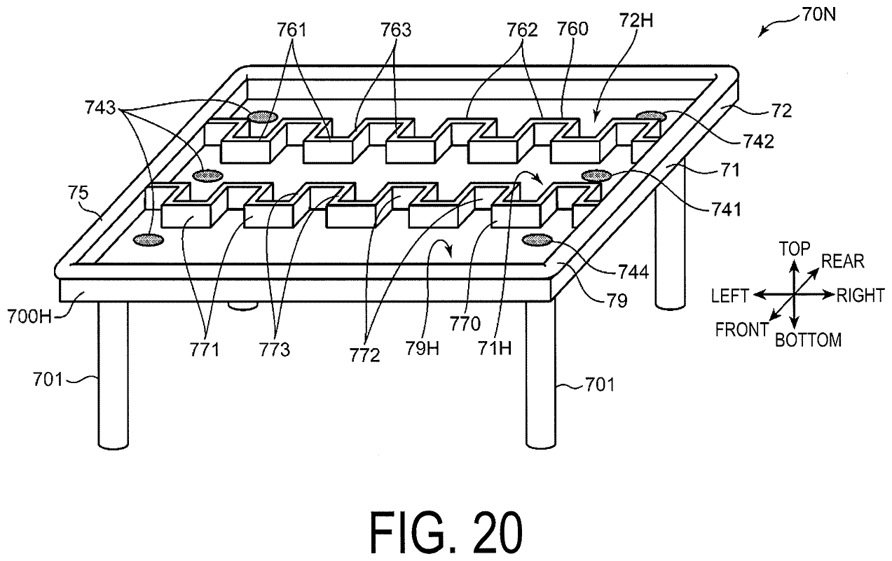

FIG. 20 is a perspective view of a container unit 70N (container) according to a second variation embodiment of the present disclosure. The present variation embodiment is different from the first variation embodiment in that the container unit 70N further includes a partition 770. The partition 770 has a structure the same as, and/or similar to, that of the partition 760, and partitions a portion of the container main body 700H further to the front side than the pre-processing liquid container 72 (pre-processing container portion) into the ink container 71 (ink container portion) and a post-processing container 79 (post-processing container portion). The post-processing container 79 includes a second opening 79H receiving the post-processing liquid ejected from the post-processing head 6. A processing liquid passage 744 is formed in the post-processing container 79 in addition to the above-described relay passage 743. The processing liquid passage 744 is an opening through which the post-processing liquid mixed with the cleaning liquid is ejected.

That is, in the present variation embodiment, the partitions 760 and 770 partition the container main body 700H of the container unit 70N so as to form the pre-processing liquid container 72 receiving the pre-processing liquid ejected from the pre-processing head 5 and the post-processing container 79 disposed independently of the pre-processing liquid container 72 and receiving the post-processing liquid ejected from the post-processing head 6.

Specifically, as in the partition 760, the partition 770 includes a plurality of lateral plates 771 and a plurality of lateral plates 772 (first portions), and a plurality of vertical plates 773 (second portions) connected to these lateral plates, respectively. The partition 770 partitions the container main body 700H two dimensionally rather than linearly. More specifically, in the periphery of the partition 770, the rear end portion of the ink container 71 and the front end portion of the post-processing container 79 are disposed in a staggered manner. Thus, while the downstream-side heads 4A2 to 4H2 of the ink heads 4 in FIG. 9 (region B) can be disposed above the ink container 71 side of a space portion of the staggered shape corresponding to the ink container 71 side, the post-processing head 6 can be disposed above the post-processing container 79 side, and the degree of freedom in the arrangement of the pre-processing head 5, the ink heads 4, and the post-processing head 6 can be increased as in FIG. 9 (region B). In the example in FIG. 20, the position of the post-processing head 6 in FIG. 9 (region B) can be also moved between the adjacent ones of heads of the downstream-side heads 4A2 to 4H2. One or more post-processing heads 6 can also be disposed at these positions.

Also in the present variation embodiment, each ink wiper 82 moves along a predetermined movement path when executing the wiping of the ink head 4, but the second opening 79H of the post-processing container 79 is disposed at a position without a region directly below the entirety of the movement path of the ink wiper 82, specifically, in front of the movement path. Thus, in such a configuration, the ink can be suppressed from entering the post-processing container 79 when the ink wiper 82 moves. Thus, it is useful when the ink and the post-processing liquid easily react with each other.

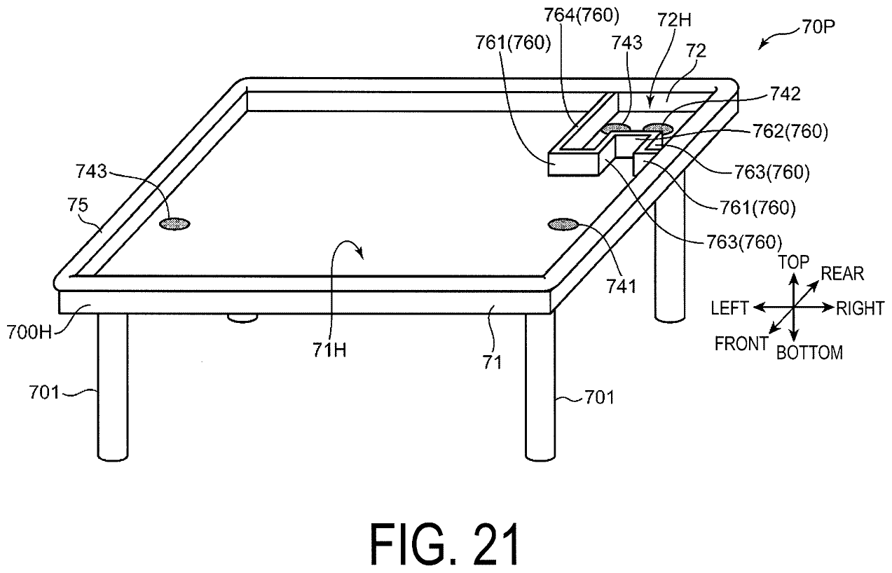

FIG. 21 is a perspective view of a container unit 70P (container) according to a third variation embodiment of the present disclosure. In the present variation embodiment, the pre-processing liquid container 72 is formed at a corner portion of the container main body 700H on the right rear side, and the ink container 71 is formed at the other portion. The ink and the post-processing liquid are collected in the ink container 71. The ink container 71 and the pre-processing liquid container 72 are partitioned by the partition 760, and the partition 760 includes a plurality of the lateral plates 761 and one lateral plate 762 (both are first portions), and one vertical plate 764 (second portion) connected to one lateral plate 761. In the present variation embodiment, as an example, two pre-processing heads 5 can be disposed above recessed portions, respectively, on both the left and right sides of the lateral plate 762 corresponding to the recessed portions.

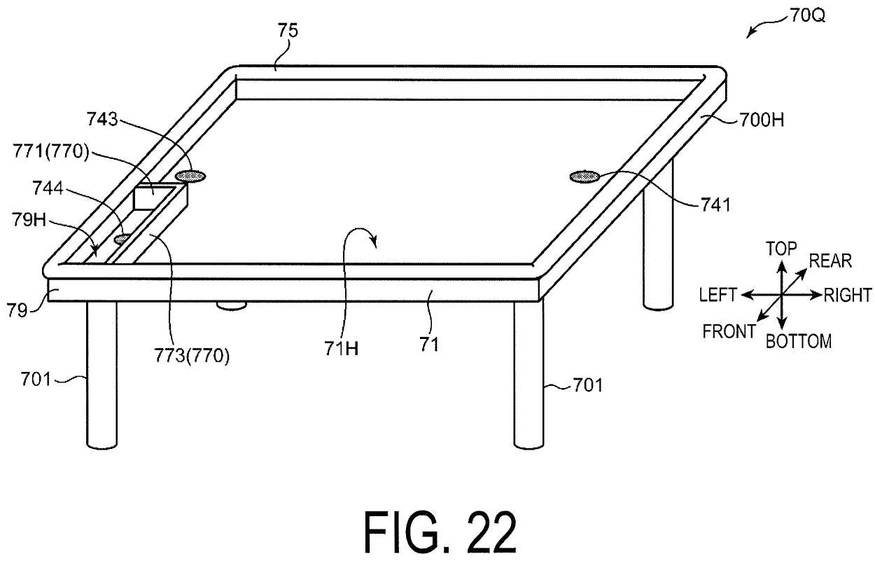

FIG. 22 is a perspective view of a container unit 70Q (container) according to a fourth variation embodiment of the present disclosure. In the present variation embodiment, the post-processing container 79 is formed at a corner portion of the container main body 700H on the left front side, and the ink container 71 is formed at the other portion. In the present variation embodiment, the first opening 71H of the ink container 71 receives the ink and the pre-processing liquid (one processing liquid), and the second opening 79H of the post-processing container 79 receives only the post-processing liquid (the other processing liquid). The ink container 71 and the post-processing container 79 are partitioned by the partition 770, and the partition 770 includes one lateral plate 771 (first portion) and one vertical plate 773 (second portion) connected to the one lateral plate 771. In the present variation embodiment, one post-processing head 6 can be disposed above the post-processing container 79.

It is assumed that, instead of the post-processing container 79 illustrated in FIG. 22, the post-processing container 79 is formed at a corner portion of the container main body 700H on the right front side. In this case, as an example, only the post-processing head 6B in FIG. 9 (region B) is disposed as the post-processing head 6 on the carriage 3. Each ink wiper 82 moves along a predetermined movement path when executing the wiping of the ink head 4, but the second opening 79H of the post-processing container 79 is disposed at a position without a region directly below the entirety of the movement path of the ink wiper 82. Thus, also in such a configuration, the ink can be suppressed from entering the post-processing container 79 when the ink wiper 82 moves.

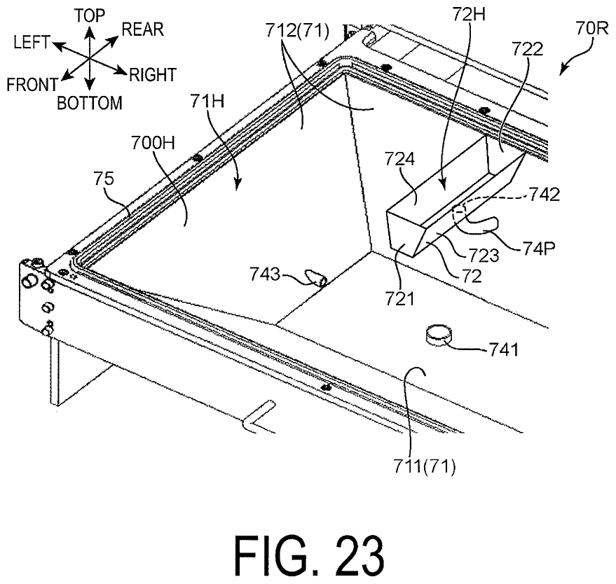

FIG. 23 is a perspective view of a container unit 70R (container) according to a fifth variation embodiment of the present disclosure. The present variation embodiment corresponds to a mode in which the pre-processing liquid container 72 in the previous embodiment illustrated in FIGS. 8A and 8B is moved to the right side. In this case, the position of the pre-processing head 5 in FIG. 9 (region B) can be moved between the adjacent ones of heads of the upstream-side heads 4A1 to 4H1.

In the present variation embodiment, the front wall 721 (first portion) partitions the container unit 70R in the front-rear direction, and the right wall 723 and the left wall 724 (second portion) partition the container unit 70R in the left and right directions, respectively. The processing liquid passage 742 is open in the bottom portion of the pre-processing liquid container 72, and the pre-processing liquid ejected through the processing liquid passage 742 is guided to the tapered surface 712 on the rear side of the container unit 70R by a relay pipe 74P. Thereafter, the ejected pre-processing liquid merges with the waste liquid hoses 704 (FIG. 8A).

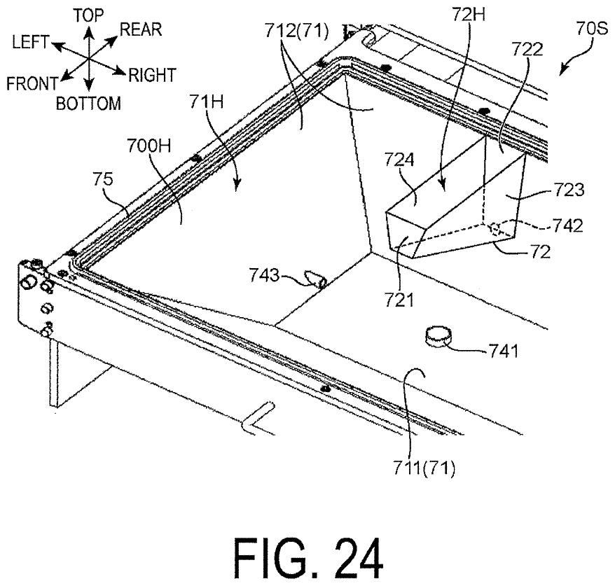

FIG. 24 is a perspective view of a container unit 70S (container) according to a sixth variation embodiment of the present disclosure. The present variation embodiment is different 20 from the fifth variation embodiment mainly in that the bottom surface of the pre-processing liquid container 72 is inclined. That is, the bottom surface of the pre-processing liquid container 72 is inclined downward and rearward, and a processing liquid passage 742 (eject hole) ejecting the pre-processing liquid from the pre-processing liquid container 72 is opened at an intersecting line between the bottom surface and the tapered surface 712 on the rear side. According to such a configuration, the collected pre-processing liquid can be smoothly guided to the processing liquid passage 742 by the inclination of the bottom portion, and thus collectability of the pre-processing liquid, the aggregation in the pre-processing liquid container 72, and the like can be suppressed.

In the present variation embodiment, the processing liquid passage 742 is disposed at a downstream-side portion (downstream end portion) of the pre-processing liquid container 72 in the movement direction when the pre-processing liquid wiper 83 wipes the pre-processing head 5. According to such a configuration, the processing liquid passage 742 can be disposed near a place where the pre-processing liquid drips from the pre-processing liquid wiper 83 and fixation of the pre-processing liquid inside the pre-processing liquid container 72 can be reduced by narrowing a range where the pre-processing liquid adheres inside the pre-processing liquid container 72.

In the present variation embodiment, as illustrated in FIG. 24, the bottom surface of the pre-processing liquid container 72 includes a portion that becomes deeper toward a downstream side in the movement direction of the pre-processing liquid wiper 83. Thus, the collected pre-processing liquid can be more easily ejected.

In FIG. 24, the cap rubber 75 may be attached not only to the outer peripheral edge of the ink container 71 but also to the outer peripheral edge of the pre-processing liquid container 72. In this case, the container unit 70 also serves as a head cap capable of capping the ink head 4 and the post-processing head 6, and the pre-processing head 5 independently (individually) from each other. Thus, even in a case where a volatile component of the pre-processing liquid is mixed with the ink and aggregation may occur, such an aggregation can be reduced. As described above, only the pre-processing head 5 may be independently capped, or the post-processing head 6 may be further independently capped.

As in the pre-processing liquid container 72 illustrated in FIG. 8A and FIG. 8B, in the fifth variation embodiment and the sixth variation embodiment described above, the pre-processing liquid container 72 is disposed so as to overlap the ink container 71 in a plan view. Further, a part of the pre-processing liquid container 72 is formed using a wall surface (tapered surface 712) which is one surface of a respective one of the container unit 70R and the container unit 70S. As a result, in a plan view, one side of each pre-processing liquid container 72 is shared by a respective one of the container units 70R and 70S, and the other three sides are disposed so as to float in the air. Thus, while the pre-processing liquid container 72 is disposed above the ink container 71, the rigidity of the pre-processing liquid container 72 can be increased as compared with a case where the wall surface of the pre-processing liquid container 72 is completely independent of the ink container 71 and the pre-processing liquid container 72 can be prevented from being deformed by the influence of gravity.

The partition structures of the container units 70 to 70S described in the embodiments, respectively, are not limited to the container collecting the liquid (ink or processing liquid) dripping during wiping. As an example, the container units 70 to 70S may each be a flushing container capable of receiving the ink and the processing liquid ejected from the ink head 4 and the processing liquid head (the pre-processing head 5 and the post-processing head 6) during flushing. Also in this case, the degree of freedom in the arrangement of each head can be increased, and the mixing of the ink and the processing liquid during flushing can be reduced. In the case of the flushing container, the container main body may be partitioned by a partition linearly extending in one direction. The one direction may be the movement direction of the carriage 3 or may be a direction perpendicular to the movement direction of the carriage 3.

1. An inkjet recording apparatus comprising:
at least one head configured to eject liquid respectively; and
a container comprising
a container body with an opening, the opening being configured to receive liquid ejected from the at least one head, and
a partition configured to partition the container body into a plurality of regions which are independent each other,
wherein the partition comprises:
at least one first portion configured to partition the container body in a first direction; and
at least one second portion configured to partition the container body in a second direction intersecting the first direction.

2. The inkjet recording apparatus according to claim 1,
wherein the at least one first portion comprises a plurality of first portions.

3. The inkjet recording apparatus according to claim 1,
wherein the at least one second portion comprises a plurality of second portions.

4. The inkjet recording apparatus according to claim 1,
wherein the at least one head comprises:
an ink head configured to eject ink; and
a treatment liquid head configured to eject treatment liquid, and
wherein the partition is configured to partition the container body into an ink container portion with a first opening, the first opening being configured to receive the ink ejected from the ink head and a treatment liquid container portion with a second opening, the second opening being configured to receive the treatment liquid ejected from the treatment liquid head.

5. The inkjet recording apparatus according to claim 4,
wherein the treatment liquid head comprises:
a pre-treatment head configured to eject pre-treatment liquid; and
a post-treatment head configured to eject post-treatment liquid, and
wherein the partition partitions the container body, the first opening of the ink container portion is configured to receive one treatment liquid of the pre-treatment liquid ejected from the pre-treatment head and the post-treatment liquid ejected from the post-treatment head, and the ink ejected from the ink head, and the second opening of the treatment liquid container portion is configured to receive the other treatment liquid of the pre-treatment liquid ejected from the pre-treatment head and the post-treatment liquid ejected from the post-treatment head.

6. The inkjet recording apparatus according to claim 4,
wherein the treatment liquid head comprises:
a pre-treatment head configured to eject pre-treatment liquid; and
a post-treatment head configured to eject post-treatment liquid, and
wherein the partition partitions the container body, and the treatment liquid container portion comprises a pre-treatment container portion configured to receive the pre-treatment liquid ejected from the pre-treatment head and a post-treatment container portion independently located of the pre-treatment container portion and configured to receive the post-treatment liquid ejected from the post-treatment head.

7. The inkjet recording apparatus according to claim 4,
wherein a depth of the treatment liquid container is shallower than a depth of the ink container portion.

8. The inkjet recording apparatus according to claim 7,
wherein the container body comprises an inclined surface configured to define the ink container portion together with the partition, and
wherein a part of the inclined surface further defines the treatment liquid container portion above a bottom portion of the ink container portion, the depth of the treatment liquid container portion being shallower than the depth of the ink container portion.

9. The inkjet recording apparatus according to claim 4,
wherein the treatment liquid container portion comprises an inclined bottom surface, and the inclined bottom surface is configured to guide the treatment liquid received from the treatment liquid head in a predetermined direction as the treatment liquid proceeds downward.

10. The inkjet recording apparatus according to claim 4,
wherein a bottom surface of the treatment liquid container portion is located above a bottom surface of the ink container portion.

11. The inkjet recording apparatus according to claim 4 further comprising a wiping unit comprising:
an ink wiper configured to wipe the ink head; and
a treatment liquid wiper configured to wipe the treatment liquid head,
wherein the ink container portion is configured to receive, from the first opening, ink falling from the ink head at the time of wiping of the ink wiper, and
wherein the treatment liquid container portion is configured to receive, from the second opening, treatment liquid falling from the treatment liquid head during the wiping of the treatment liquid wiper.

12. The inkjet recording apparatus according to claim 11,
wherein the treatment liquid wiper is configured to move along a predetermined movement path when the wiping, and
wherein the first opening of the ink container portion is located at a position without a region directly below whole the movement path.

13. The inkjet recording apparatus according to claim 11,
wherein the ink wiper is configured to move along a predetermined movement path when the wiping, and
wherein the second opening of the treatment liquid container portion is located at a position without a region directly below whole the movement path.

14. The inkjet recording apparatus according to claim 11, further comprising a printing area where an ink is ejected from the ink head to form an image,
wherein in a movement direction in which the head moves from the printing area to an area where the wiping is performed, the treatment liquid container portion is located at a position closer to the printing area than the ink container portion.

15. The inkjet recording apparatus according to claim 11,
wherein the treatment liquid container portion comprises an ejection hole through configured to eject the treatment liquid from the treatment liquid container, and
wherein the ejection hole is located in a downstream-side portion of the treatment liquid container portion in a movement direction when the treatment liquid wiper wipes the treatment liquid head.

16. The inkjet recording apparatus according to claim 11,
wherein a bottom portion of the treatment liquid container portion comprises a portion becoming deeper toward a downstream side in the movement direction when the treatment liquid wiper wipes the treatment liquid head.

17-21. (canceled)

22. The inkjet recording apparatus according to claim 1, further comprising:
a housing; and
a wiping unit comprising a wiper configured to wipe the head and configured to be pulled out from the housing,
wherein a pull-out direction of the wiping unit is a direction along a movement direction when the wiper wipes the head.

23. The inkjet recording apparatus according to claim 1, further comprising:
a wiper configured to wipe the head;
a cleaning portion configured to inject cleaning liquid to clean the wiper;
a cleaning liquid supply portion configured to supply the cleaning liquid having passed through the wiper to the container body; and
an ejection hole configured to eject the liquid and the cleaning liquid mixed with each other in the container body.

24. The inkjet recording apparatus according to claim 4,
wherein the container is a head cap configured to individually cap the ink head and the treatment liquid head.

25. The inkjet recording apparatus according to claim 4,
wherein the container is a flushing container configured to receive the ink and the treatment liquid ejected from the ink head and the treatment liquid head, respectively, at the time of flushing.
